(19) United States
(12) Patent Application Publication
(10) Pub. No.: US 2004/0175598 A1
(43) Pub. Date: Sep. 9, 2004

(54) Fuel cell power supply for portable computing device and method for fuel cell power control

(76) Inventors: David C. Bliven, Cupertino, CA (US); Alan I. Attia, Corrales, NM (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/727,090

(22) Filed: Dec. 2, 2003

Related U.S. Application Data
(60) Provisional application No. 60/430,591, filed on Dec. 2, 2002.
(60) Provisional application No. 60/517,469, filed on Nov. 4, 2003.
(60) Provisional application No. 60/431,139, filed on Dec. 4, 2002.

(51) Int. Cl. H01M 8/04; G06F 1/26

(52) U.S. Cl. 429/12; 429/22; 713/340

(57) ABSTRACT

Electronic circuit and control system and method in hardware and software for controlling fuel cell and fuel cell powered electrical or electronic device. System, device, method and computer program and computer program product for monitoring and controlling fuel cell based power supply and powered information appliance, such as mobile telephone and laptop computer. Fuel cell for powering and fuel cell powered information appliance or computer. Fuel cell power pack adapted to provide electrical operating power to an electrical device. Interface circuit and control device and method for a fuel cell powered electronic device. Method of controlling operation of a fuel cell to generate electricity for an electrical device. Electrical control power pack adapted to replace battery for a laptop computer.

### RELATED APPLICATIONS

This application is related to and claims the benefit of priority under 35 U.S.C. 119(e) to U.S. Provisional Application No. 60/430,591 filed 2 Dec. 2002 and entitled Improved Laptop Computer Fuel Cell Based Recharge Power Supply And Method, which is herein incorporated by reference in its entirety.

This application is also related to and claims the benefit under 35 U.S.C. 119(e) and/or 120 of U.S. patent application Ser. No. 10/309,954, filed Dec. 3, 2002 entitled Fuel Cell Assembly For Portable Electronic Device And Interface, Control, And Regulator Circuit For Fuel Cell Powered Electronic Device; U.S. Provisional Patent Application No. 60/517,469 filed Nov. 4, 2003, entitled Fuel Cell Assembly For Portable Electronic Device; U.S. Provisional Patent Application No. 60/431,139 filed Dec. 4, 2002, entitled Improved Fuel Cell And Fuel Cell Assembly For Portable Electronic Device; U.S. patent application Ser. No. 10/______ (Attorney Docket No. A-70547-2/RFT/VEJ), filed Dec. 1, 2003 entitled Fuel Cell Cartridge For Portable Electronic Device, the entire content of which applications is incorporated herein by this reference.

### FIELD OF THE INVENTION

This invention pertains generally to electronics and control systems in hardware and software for controlling a fuel cell and fuel cell powered electrical or electronic device; and more particularly pertains to systems, devices, methods and computer programs for monitoring and controlling a fuel cell powered information appliances such as mobile telephones and laptop or other portable computers.

### BACKGROUND

Fuel cells have been projected as promising power sources for portable electronic devices, electric vehicles, and other applications due mainly to their non-polluting nature.

Heretofore, fuel cell systems for powering electronic devices have not achieved any great measure of commercial success, at least in part because of the difficulties associated with (i) providing a fuel cell in a physical package that would be adopted by device manufactures, particularly for mobile telephone applications and notebook computer applications, and (ii) achieving and regulating required power (voltage and current) levels with acceptable reliability, consistency, and safety.

These limitations have been particularly problematic where the power requirements of the electronic device tend to vary at different phases of operation and/or where higher levels of power are required for sustained operation. For example, in a mobile cellular phone, the power requirements are quite modest for standby operation while waiting to receive a call, increase when receiving the call, and then raise tremendously while in a transmit mode. The voltage and wattage requirements for continuous operation of a notebook computer or other portable computing device or information appliance also present problems to providing required voltage adequate lifetime before replacement of refueling.

The need to manage power generation by the fuel cell or set of fuel cells as well as the need to control power draw by the device in a safe many has also limited to commercial success or fuel cells and fuel cell powered electrical and electronic devices and systems. These and other circumstances require or benefit from a interface and control circuits and methods that permits connection of a fuel cell based power supply to electronic devices and advantageously connection and interchangeable use or retrofit of fuel cell based power supplies or systems to existing electronic devices, and the management and control of the fuel cell based power supply.

What is needed, among other things, is an interface circuit adapted to control and regulate power draw and charge/discharge from both the fuel cell and the battery to maintain operation within predefined voltage, current, and power ranges and to maintain safety when either or both flammable fluids associated with operation of the fuel cell and explosive materials associated with the operation of Lithium-Ion batteries are present.

There also remains a need for a control method that maintains fuel cell operation within defined power generation and safety parameters and prevents damage to the fuel cell based power supply and to the powered device.

There further remains a need for a hardware and micro-controller based control system and method that is responsive to different conditions and event occurrences in the fuel cell based power supply and/or the powered device.

There remains yet another need for a fuel cell powered electronic device such as a fuel cell powered mobile, cellular, or satellite telephone or other communication device as well as for a fuel cell powered laptop computer or other portable computing device or information appliance.

### BRIEF DESCRIPTION OF THE DRAWINGS

FIG. 1 is a diagrammatic illustration showing elements of power converter, control, and fuel cell power system support and storage system for use in or with a laptop computer or other electronic device or system.

FIG. 2 shows one embodiment of the laptop computer or information appliance general layout and control scheme, such as for example may be used with one or more of the systems illustrated in FIGS. 17-21.

FIG. 3 is a schematic circuit diagram showing an embodiment of an interface and control circuit for use in combination with a fuel cell battery pack and an electronic device powered by one or both of the fuel cell and battery, and that provides charge and discharge circuitry for use with a laptop computer or other electronic device in accordance with the present invention.

FIG. 4 is a diagrammatic illustration showing an exemplary typical power curve for an embodiment of a fuel cell.

FIG. 5 is a diagrammatic illustration showing of state diagrams for first and second embodiments of laptop computer boost converter and processor control.

FIG. 6 is a diagrammatic flow-chart illustration showing an embodiment of a procedure for controlling aspects of operation of the interface and control circuit of FIG. 3.

FIG. 7 is an illustration showing exemplary computer program code and pseudo code for use with an embodiment of the invention utilizing a microprocessor or microcontroller to accomplish a portion of the control of operation of the interface and control circuit of FIG. 6 in accordance with an aspect of the invention.

FIG. 8 is a diagrammatic illustration showing a computer program microprocessor or micro-controller implemented control scheme for controlling fuel cell operation in or with a laptop computer or other electronic device, and particularly showing main, on-loop, off-loop, and Fuel Cell Service sub-procedures, for use in or with a laptop computer or other electronic device or system.

FIG. 9 is a diagrammatic flow-chart illustration showing an embodiment of an initialization procedure in accordance with an aspect of the present invention.

FIG. 10 is a diagrammatic flow-chart illustration showing an embodiment of TIC ISR procedure in accordance with the present invention.

FIG. 11 is a diagrammatic flow-chart illustration showing an embodiment of a T0 Overflow ISR procedure in accordance with the present invention.

FIG. 12 is a diagrammatic flow-chart illustration showing an embodiment of Compare ISR procedure in accordance with the present invention.

FIG. 13 is a diagrammatic flow-chart illustration showing an embodiment of a Flash procedure in accordance with the present invention.

FIG. 14 is a diagrammatic flow-chart illustration showing an embodiment of a Load Test procedure in accordance with the present invention.

FIG. 15 is a diagrammatic flow-chart illustration showing an embodiment of a ADC procedure in accordance with the present invention.

FIG. 16 is a diagrammatic flow-chart illustration showing an embodiment of a Wait procedure in accordance with the present invention.

FIG. 17 is a diagrammatic functional block diagram of an embodiment of a fuel cell based system for generating electrical energy from one or more fuel cells including control elements, fuel cells, actuators, sensors, pumps, and various reservoirs for fuel and water.

FIG. 18 shows yet another embodiment of a laptop computer system, information appliance, or other electrical or electronic device.

FIG. 19 shows yet another alternative configuration of a laptop computer system, information appliance, or other electrical or electronic device according to the invention.

FIG. 20 shows still another alternative configuration of a laptop computer system, information appliance, or other electrical or electronic device utilizing a simpler configuration and having no separate heat exchanger.

FIG. 21 shows still another alternative configuration of a laptop computer system, information appliance, or other electrical or electronic device according to the invention.

FIG. 22 is a diagrammatic illustration showing a particular embodiment of a power supply control system with emphasis on the connectivity of the micro-controller to the boost converter, fuel cell circuits, actuators, and sensors.

FIG. 23 is a diagrammatic illustration showing an embodiment of a high-level system control process and methodology and various startup, idle, run, shutdown, and data up-load and data-download processes.

FIG. 24 is a diagrammatic illustration showing an embodiment of a startup sequence process of the control process and methodology of FIG. 23.

FIG. 25 is a diagrammatic illustration showing an embodiment of an idle sequence process of the control process and methodology of FIG. 23.

FIG. 26 is a diagrammatic illustration showing an embodiment of a run sequence process of the control process and methodology of FIG. 23.

FIG. 27 is a diagrammatic illustration showing an embodiment of a data upload sequence process of the control process and methodology of FIG. 23.

FIG. 28 is a diagrammatic illustration showing an embodiment of a shutdown sequence process of the control process and methodology of FIG. 23.

FIG. 29 is a diagrammatic illustration showing an embodiment of a laptop computer having a fuel cell power pack coupled to the DC battery input of the laptop computer.

### SUMMARY

Electronic circuit and control system and method in hardware and software for controlling fuel cell and fuel cell powered electrical or electronic device. System, device, method and computer program and computer program product for monitoring and controlling a fuel cell based power supply and powered information appliance, such as mobile telephone and laptop or other portable computer. A fuel cell powered information appliance such as a laptop computer including a processor for executing computer instructions, memory or register communicatively coupled to the processor, fuel cell generating electrical power and coupled to at least one of the processor and the memory for providing operating power (voltage and current) to operating electrical circuits within the processor and memory.

A power pack adapted to provide electrical operating power to an electrical device including: a fuel cell assembly, an electrical interface circuit receiving a voltage and current from the fuel cell assembly and generating an electrical output voltage and current for operation of the electrical device, the electrical interface including a controller executing a control procedure for managing operation of the fuel cell assembly and the electrical device according to a predetermined control procedure; and a housing enclosing the fuel cell assembly and the electrical interface circuit.

An interface circuit for a fuel cell powered electronic device including a DC-DC voltage boost circuit operating with an output voltage related feedback signal; a storage capacitor coupled to and receiving charge generated by said boost circuit; and a microcontroller coupled to said boost circuit for controlling operation or non-operation of said boost circuit.

A method of controlling operation of a voltage boost converter circuit coupled to a fuel cell.

An interface circuit for a fuel cell powered information appliance including: a DC-DC voltage boost circuit operating with an output voltage related feedback signal to boost a lower fuel cell output voltage to a higher voltage operating voltage of said information appliance; a storage capacitor and a storage battery coupled to and receiving charge generated by said boost circuit, said boot converter circuit further operating to limiting a storage battery charging current to a predetermined current less than a current that would damage said storage battery; and a microcontroller adapted to execute instructions to modify and control the operation of the microprocessor and coupled to said boost circuit for controlling operation or non-operation of said boost circuit based on a fuel cell output voltage; said interface circuit being adapted to control and regulate power drawn from and charge and discharge of a fuel cell and maintain safe operation within predefined voltage, current, and power ranges, and said cellular telephone having a power consumption ranging between substantially 10 watts and 60 watts and an operating voltage range between substantially 5 volts and 20 volts.

An electrical control power pack specifically adapted to replace a battery for a laptop computer having a laptop computer body, said power pack including a fuel cell assembly; a housing adapted to removably engage the laptop computer body, said housing enclosing said fuel cell assembly and said fuel cartridge; and an interface circuit including: a DC-DC voltage boost circuit operating with an output voltage related feedback signal; a storage capacitor coupled to and receiving charge generated by said boost circuit; and a microcontroller coupled to said boost circuit for controlling operation or non-operation of said boost circuit.

### DETAILED DESCRIPTION OF THE EMBODIMENTS

Embodiment of a Power Converter System Having Boost Converter and Micro-Controller

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

In embodiments of the system, method, computer program software, and circuit described herein, reference is made to a fuel cell, fuel cell assembly, or one or a plurality of fuel cell stacks, adapted for use with a mobile telephone such as a cellular phone. The invention may find particular utility when used in conjunction with the fuel cell assembly and electronic device described in U.S. patent application Ser. No. 10/161,558 (Atty. Doc. No. A-70547/RFT/VEG) filed 31 May 2002 and entitled Fuel Cell Assembly for Portable Electronic Device and Interface, Control, and Regulator Circuit for Fuel Cell Powered Electronic Device, herein incorporated by reference. For example, a fuel cell assembly may be used to provide a continuous source of power for a mobile telephone, a laptop computer or other portable computing device or information appliance. One type of such telephone may typically have a power consumption ranging between about 360 mA at 3.3 V (1.2 W), when located nearest to a respective transmitter, and about 600 mA at 3.3 V (1.98 W) when located furthest from a respective transmitter.

Other embodiments of the invention are described as having particularly utility or applicability to laptop computers or other portable computing devices or information appliances what may typically have power requirements from about 10 watts to about 60 watts and may operate at voltages than cellular or mobile telephones, such as at voltages in the range from about 5 volts to about 20 volts, as is known in the art.

While mobile telephones and portable computing devices are good examples of electrical and electronic devices which may incorporate, connect with, or utilize fuel cell based power, those workers having ordinary skill in the art in light of this description will appreciate that a fuel cell assembly and the interface and control system, circuit, and operating and control methods and procedures as described in accordance with the present invention can be configured to provide a continuous source of power (or intermittent source if desired) for other portable or stationary electrical or electronic devices and system having various power consumption and voltage ranges and still fall within the scope of the present invention.

For example, the interface and control circuit and method of control may be used in conjunction with a fuel cell assembly in accordance with the present invention can be used to power cell phones and other telecommunication devices, video and audio consumer electronics equipment, computer laptops, computer notebooks, personal digital assistants and other computing devices, geographic positioning systems (GPS's) and the like. Other uses to which the invention finds particular use includes the use of fuel cell assemblies in residential, industrial, commercial power systems and for use in locomotive power such as in automobiles. For higher power delivery applications, certain components will be modified so as to provide the required voltage or current handling capabilities. For example, capacitors, resistors, transistors, diodes, and other components may be modified in value to provide the desired operation and power handling capability.

Furthermore, although the inventive interface and control circuit and method find particular applicability to fuel cell powered devices, the invention is not limited to such fuel cell powered devices, but rather may have applicability to other power sources that require of benefit from the type of interface, control, regulation, and monitoring provided by the invention. It will therefore be understood to be useful when an electronic device uses any source or combination of sources of electrical energy or power. Multiple such interface and control circuits may for example be arrayed to control a multiplicity of energy sources, including for example, solar or photovoltaic sources, capacitive storage, chemical storage, fuel cell, set of batteries having similar or dissimilar voltage, current, or power delivery or charge-discharge characteristics, and the like.

When a fuel cell or fuel cell assembly is involved, the fuel cell or fuel cell assembly may typically include at least two electrodes appropriate to the voltage and current generated therein. The two electrodes coupled with the fuel cell are capable of completing an electrical circuit through the inventive circuit with a load, where the load may be the cellular telephone or other electronic device to which a electric current is supplied.

In one aspect and at a conceptual level, the inventive interface and control circuit provides a voltage regulator function which includes circuit elements and an (optional) storage battery for monitoring and/or regulating voltage and/or power supplied to the portable electronic device. However, in particular embodiments of the invention, the inventive interface and control circuit provide operational features, capabilities, and advantages that go far beyond voltage, current, or power regulation.

The electronic device, such as a mobile or cellular telephone, asks for power. In fact, typical phones will accept a voltage within an acceptable range of voltages (for example a voltage between about 3.3. to 4.3 volts with nominal 3.6 operating voltage) and will then attempt to draw current appropriate to the voltage present and the power required for its then current state of operation. Power requirements may vary considerably during operations, for example from as little as one or a few milliwatts to 1.8 watts at full operating power given certain antenna distance and transmission mode characteristics. Note that these voltage and current operational characteristics derive at least in part from the fact that the devices, such as mobile phones, have been designed to operate from a battery having these characteristics.

It will therefore be appreciated that the inventive system and method may readily be utilized for powering an information appliance, such as a personal computer, notebook computer, laptop computer, personal data assistant (PDA), smart phone, or any of a variety of systems and devices incorporating logic circuits, controllers, processors, and/or microprocessors. In another aspect, the inventive apparatus, system, and method provides a system supply that varies watt-hours of battery recharge power to a laptop computer or other computing device or information appliance. The source of the power is a fuel cell, whose size will determine watt-hour capacity of the system. In one embodiment, the output will be about 20 volts DC (Vdc), at a maximum rate of 50 watts. In another embodiment, the output is 12-13 volts DC. Other embodiments may provide higher or lower voltages and have higher or lower wattage ratings. For example, one embodiment nominally provides 25 Watts while another embodiment nominally provides 60 Watts. It will be appreciated that the voltage, current, wattage, and other characteristics of the power provided may be adapted to the operating needs of the electrical device to which it is intended to be used.

In light of the applicability fuel cell power to a variety of electrical and electronic devices and systems, attention is directed to a variety of embodiments hardware and microcontroller based fuel cell and device power management and control methods, computer programs and processor code instructions, and circuits for use in such applications.

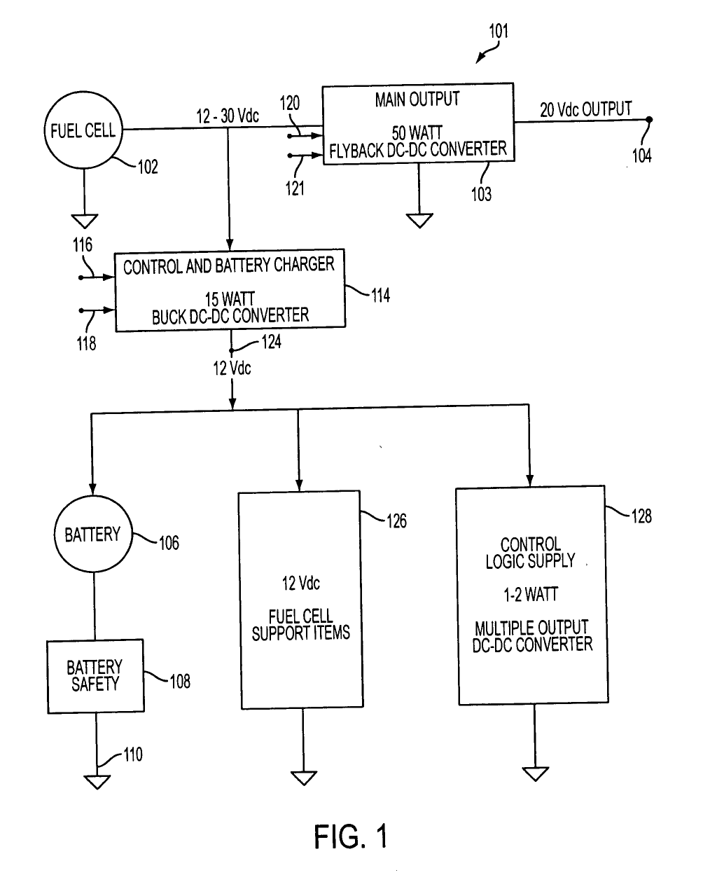

With reference to FIG. 1 there are illustrated aspects of power converter and storage system 101 for a laptop computer or other electronic device or system. In this embodiment, a main converter, herein the form of a flyback DC-DC converter 103, receives a 12 Vdc -30 Vdc voltage as the output of one or more fuel cells 102 and generates a 20 Vdc output 104. This flyback converter 103 is conveniently sized and designed to produce up to a nominal 50 watt (or other designed output power). It may also be designed and manufactured to produce desired achievable voltage and current characteristics and is not restricted to the particular values shown in the diagram or described here. This embodiment of the main converter 103 includes capability to be controlled via control inputs, such as for example control inputs 120, 121, and to operate in any of a plurality of operating modes. In one particular embodiment, the system and control provides for operation in at least three operation modes: (a) an output voltage limit of 20 Vdc, (b) an output voltage reduction range 14-20 Vdc if for example, there is a low fuel cell capacity; and (c) full on-off from the main controller. These voltage ranges are exemplary, and it will be clear to workers in the art that different voltages ranges may be implemented according to the needs of the device and constraints on the fuel cells 102 or fuel cell stacks. Some operating modes of the alternative control stage of the output power may represent a heavy system efficiency penalty.

Control power is advantageously provided, for example in the form of an adequately sized standby storage battery 106, so that power is available for control functions for a reasonable period of time for notification of no output from fuel cell before a full control shutdown or other defined period of time. A battery safety circuit 108 or device may also be provided, for example between ground 110 and a battery output terminal 112, to protect the battery 106 and the device in which the battery 106 is installed from damage.

A primary control and battery charger block 114 includes buck DC-DC converter (in this embodiment rated at 15 watts) to generate a 12 Vdc output voltage 124 from the 12-30 Vdc fuel cell (or fuel cell stack) 102 output. The output of the primary control block 114 may be used to supply power (e.g. voltage and current) for certain primary and secondary fuel cell and/or device operation support or housekeeping functions, optionally to charge battery 106, and to provide operating power to control logic.

In one embodiment, this primary control buck converter 114 has two input controls 116, 118 to permit selection of an operating mode from among a plurality of possible operating modes. In one embodiment these include: (a) an output voltage limit of 12.6 Vdc to go with the battery stack voltage limit; and (b) an output voltage reduction range 10-12.6 Vdc to limit battery charge current. These voltage ranges are exemplary of a particular design and device and are not intended to limit the scope of the invention as it will be clear that other voltage ranges may be selected according to the operation needs of the fuel cells and the device it powers. It may also be appreciated that the alternative stage of conversion for the fuel cell support drive may represent a system efficiency penalty under some conditions.

In the illustrated embodiment, the output voltage 124 provides power to charge battery 106, and to power certain fuel cell support items 126 such as sensors (e.g. temperature, level, and concentration sensors) and actuators (e.g. air and liquid pumps) as are described elsewhere in this specification. In the illustrated embodiment, these are nominally 12 Vdc components but higher or lower voltage components may readily be utilized and a mixture of different voltage levels may even be used with appropriate voltage conditioning and conversion circuitry.

The output voltage is also communicated to and used for logic elements, either directly, or via a control logic power supply 128. These logic elements may include logic circuits, microprocessor, micro-controller, or other logic and control elements as are known in the art and described herein. In one embodiment, the control logic provides control that is based on a microprocessor and support chips that manage the fuel cell and output power.

Multiple outputs at different output voltages may be generated within control logic power supply 128 as required to support various circuit or logic level requirements. Typically this control logic supply may require about 1-2 watts, but will depend on design. In one embodiment, the control logic power supply 128 uses multiple voltage flyback DC-DC converter to generate supply logic level power.

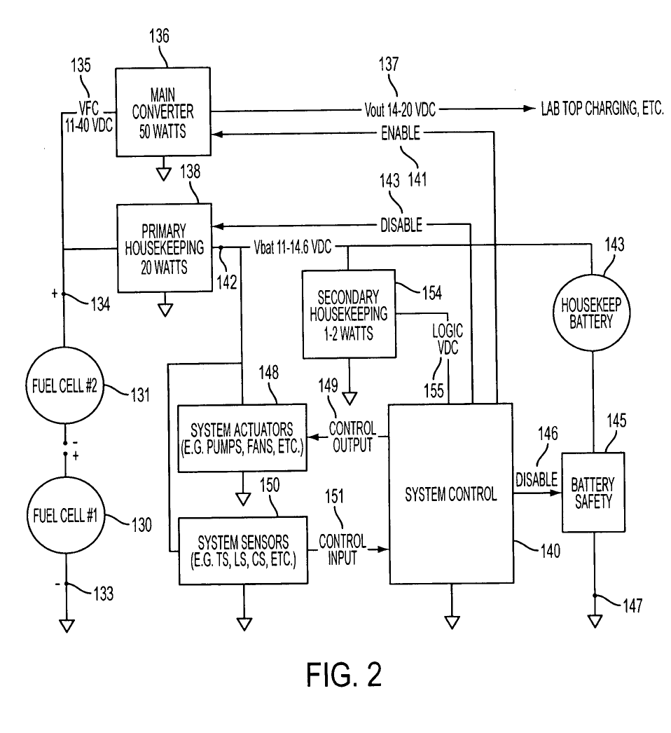

FIG. 2 shows an alternative embodiment of the laptop computer or information appliance general power distribution, layout and control configuration 130, particularly showing the distribution of fuel cell power and housekeeping battery power to components of the electrical device (e.g. laptop computer) system. It will be appreciated that this is an elaboration with additional detail and optional features of the voltage and power distribution configuration and topology illustrated in FIG. 1.

With further reference to FIG. 2, two fuel cells 130, 131 are diagrammatically show in a series connected (between a ground terminal 133 and an output terminal 134) configuration to represent any series, parallel, or series/parallel combination or stack of fuel cells. The output voltage VFC (in the range of between about 11 VDC and 40 VDC in this embodiment) is shown coupled to an input terminal of main converter block 136 and primary housekeeping block 138. Main converter 136 receives the fuel cell stack output voltage VFC 135 and generates an output voltage Vout 137 (in this embodiment, a voltage in the range of between 11 and 20 VDC) that is used for lap top charging and other operational demands of the device. The main converter block 136 is also coupled to the system control block 140 from which it may receive an enable signal 141. In this embodiment, the main converter 136 operates only when it is enabled. The exemplary main converter in this particular embodiment is rated at 50 watts, however other embodiments provide for between 20 watts and 80 watts of power, and even greater power capacity may be provided.

The primary housekeeping block 138 is electrically coupled for signal communication to the system control block 140 and in one embodiment operates unless it receives a disable signal 143 from the system control block 140. (Other embodiments may provide for alternative enable/disable logic sense to control operation.) Primary housekeeping 138 also receives a battery input Vbat 142 (in this embodiment a battery voltage in the 11-15 VDC range) from housekeeping battery 143 so that certain housekeeping functions (such as for example, fuel cell maintenance, controlled shutdown, or other defined actions can be taken even the fuel cells 130, 131 enter a condition where they are not able to maintain adequate voltage or current to otherwise provide power to such housekeeping operations. The exemplary primary housekeeping block in this particular embodiment is rated at 20 watts. An optional battery safety block 145 is connected between the housekeeping battery 143 and ground 147 and is coupled to receive a disable signal 146 from the system control block 140.

System actuators (e.g. pumps and fans) 148 receive operating power (voltage and current) as Vbat 142 from an output of the primary housekeeping block 138 and also receives control output signal(s) 149 from system control block 140. These system actuator control signal(s) may for example cause a particular actuator to operate or to stop operating, or to operate in a particular manner such as at a particular speed or for a particular period of time.

System sensors 150 (e.g. temperature sensors, level sensors, concentration sensors, or other sensors as required or desired for operation) also receive operating power (when required) from as Vbat 142 from an output of the primary housekeeping block 138 and sends sensor signal(s) 151 to the system control block 140. In some embodiments, sensors may also receive one or more control signals from the system block but in many embodiments no such control is required.

Secondary housekeeping block 154 receives an operating power as Vbat 142 from an output of the primary housekeeping block 138 and communicates with the system control block 140 through secondary housekeeping logic signal(s) 155.

System control block 140 is responsible for controlling the overall operation of the system including the main converter, primary housekeeping, secondary housekeeping, system sensors, system actuators, fuel cell(s), and battery to achieve the desired initialization, startup, operation, and power-off or shutdown. These operations are described elsewhere in this specification in greater detail.

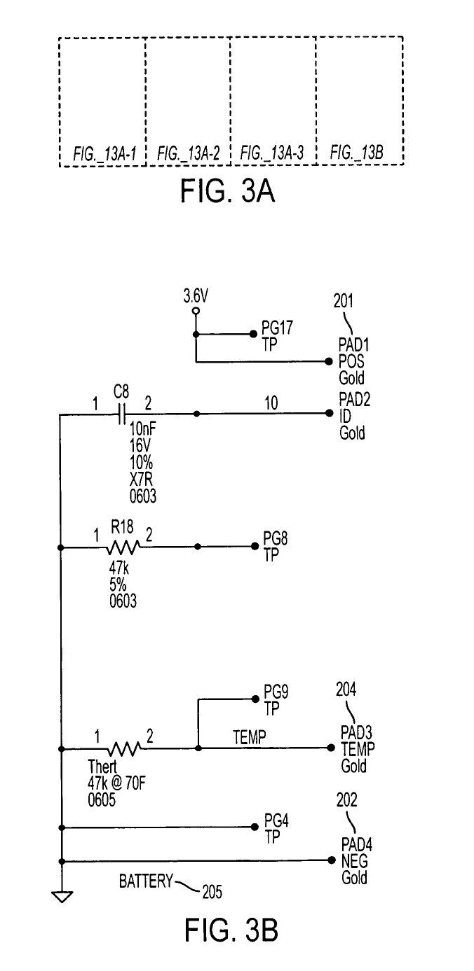

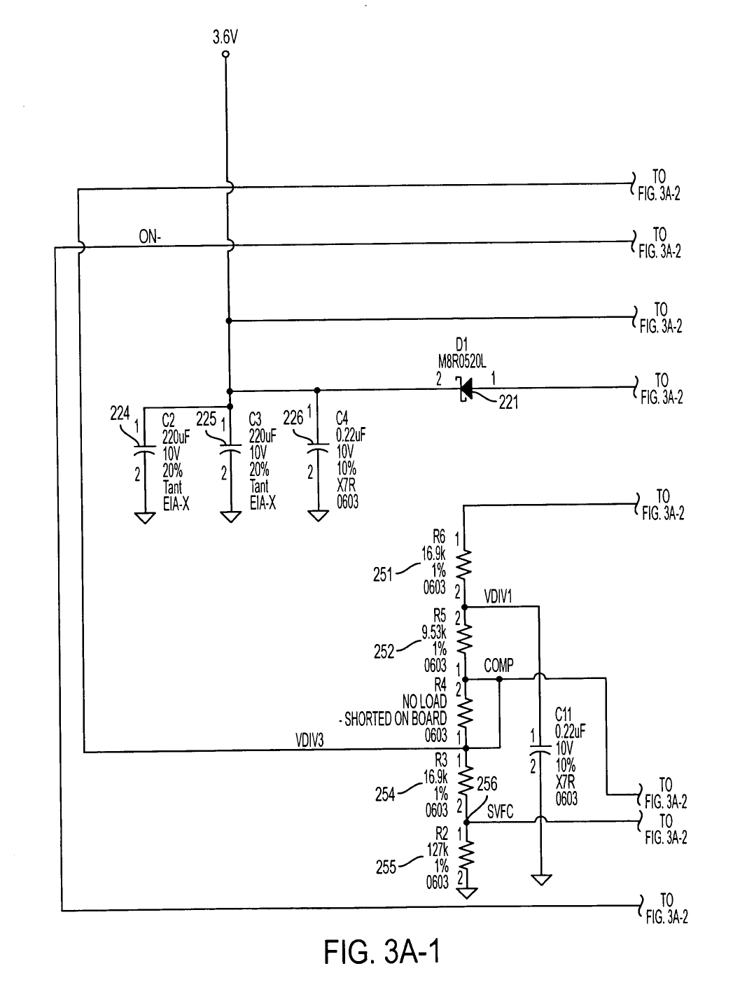

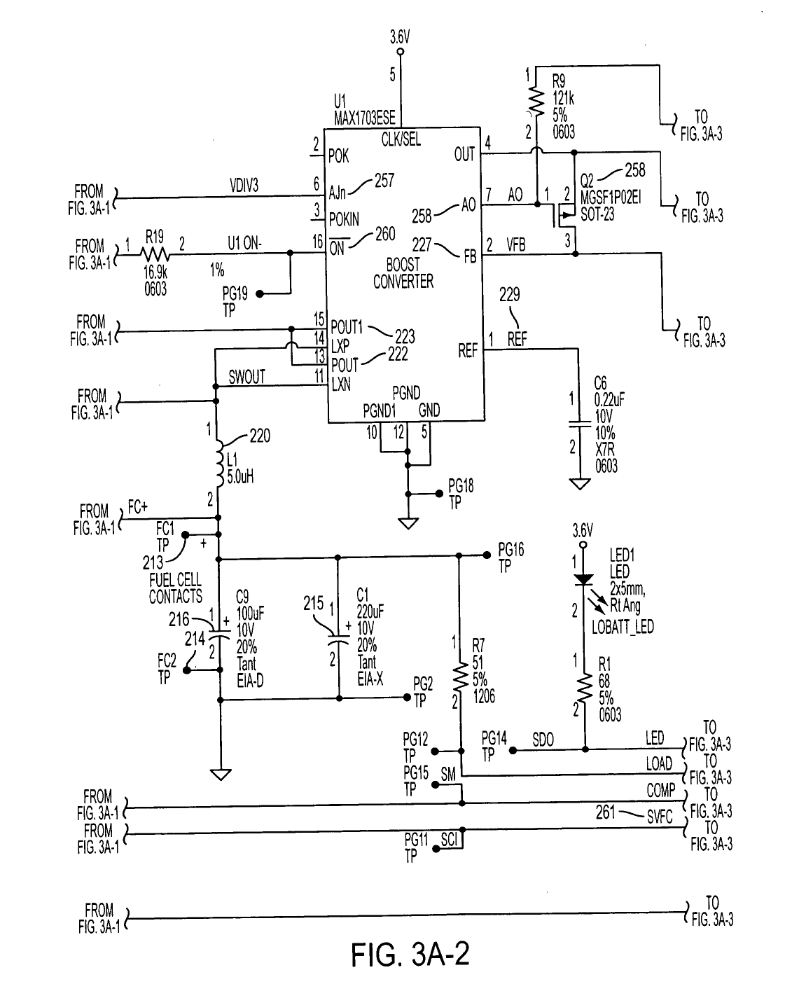

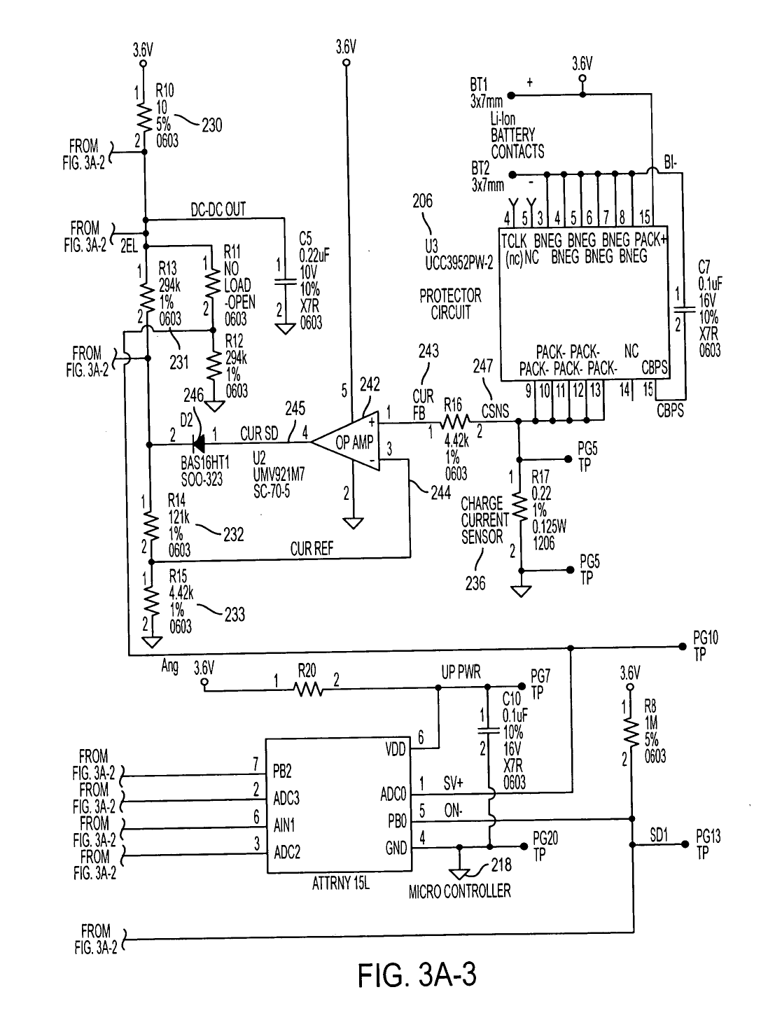

FIG. 3 shows circuits including a portion of the battery having four terminals, a POS terminal, a NEG terminal, an ID terminal, and a TEMP terminal that is particularly well suited to use in or with a mobile or cellular telephone device. These terminals of the battery in this embodiment connect to the phone of the type that supports both power (POS and NEG), battery type identification (ID), and battery temperature (TEMP) indicators. Other device configurations may advantageously be used for operation of higher power electronic devices such as portable information appliances, laptop computers, or other portable information or communication devices.

The POS terminal provides positive voltage and positive current to the phone and the NEG terminal provides negative voltage and negative current to the phone. These terminals can also direct voltage and current back into the battery in the reverse direction during charging.

The Battery type indicator is (optionally) used by the phone so that where the phone is capable of utilizing the information, such as that it is a Lithium-ion battery versus a Nickel Metal Hydride battery, such information is available to the phone or other device. The battery temperature indicator signal may typically be used to regulate charging (and discharge) to maintain the battery in a safe state and more particularly to prevent overheating from excessively fast charging. Structure and operation of batteries of the type having this terminal configuration are known in the art and not described in greater detail here.

A normal battery pack would provide the battery usually as a 900 to 1600 amp-hr battery and where the battery is a lithium-ion type which is susceptible to explosion under certain conditions, some type of battery protection circuit. For example the Texas Instrument UCC3952PW-2 is one example of a battery protection circuit in the form of an integrated circuit chip that may be used.

This protection circuit causes an open circuit to occur if there is an attempt to draw more current out of the battery, or an attempt to put too much current into the battery, or if not causing an open circuit then it will restrict the amount of current flow. It will also cause an open circuit if there is an attempt to take the voltage above 2.4 volts, and if an attempt is made to take the voltage below 3.2 volts. Note that an important aspect of the invention is the ability to take a fuel cell voltage, either from an individual fuel cell or a combination of fuel cells, and boost the fuel cell voltage to the typically higher voltage required for electrical or electronic device operation, and to manage extraction of power from the fuel cell and manage this extraction as well as charge and discharge in a manner that is efficient and does not harm the fuel cell.

In the embodiment described herein, much of the discussion is focused on Lithium ion battery technology as it is the preferred battery technology for many mobile applications. It provides lightweight yet high-capacity storage with minimal memory effects. On the other hand, Lithium-ion is a very sensitive battery type in the sense that Li-ion battery is susceptible to short circuit, over heating, and explosion problems. Protection circuits are the standard and must be close to battery to provide safety. For Nickel Metal Hydride battery types and though such protection circuit may be provided, is not normally required. The inventive circuit and method are applicable to all types of batteries and is not limited to Lithium-ion types.

In the inventive circuit, a low value resistor R17 (0.22 ohm) is provided so that the current flowing though the battery can be measured. It therefore operates as a current detector within a battery current detector circuit. Note that the resistor R17 may be considered to be a component of the inventive battery pack or of the interface and control circuit, and in alternative embodiments may be physically implemented in either way.

Attention is now directed to the boost converter circuit U1, here implemented with a MAXIM MAX1703ESE chip, that is primarily responsible for boosting the fuel cell voltage to a higher voltage level and for supplying charge to capacitive and battery storage devices within the circuit.

The two fuel cell terminals are connected across terminals FC1 and FC2. The fuel cell provides a voltage that charges C1 (100 uF) and C9 (220 uF) to some voltage, this is referred to as FC+. Note that in one embodiment, capacitor C1 is eliminated but this implementation though operational does not provide the same level of performance. FC+ can run into the 1.6 to 1.8 volt range when six fuel cells, each generating about 0.5 volts are connected in series. Fuel cell open circuit voltage (no load) may be as high as about 3.0 volts. Provision of a relatively high open circuit voltage provides enough voltage and charge so that the processor U4 described in greater detail herein elsewhere is able to initialize and exert control over the boost circuit even if both the storage capacitors and the battery are discharged. Boost converter chip U1 is capable of running at a very low voltage levels with output power between about 1 to 2 watts depending upon voltages. U1 initially turns on a circuit through LXP (pin 14) to ground and starts circulating current through Inductor L1 (5.0 uH). The current rises slowly and then the circuit is opened and the node on the U1 side of the inductor L1 quickly rises from a grounded level to a fairly high voltage level, unless clamped to prevent the voltage from rising too high. In this circuit it is clamped in two ways. First, it is clamped by D1 (MBR0520L) which prevents it from going more than about 0.5 volts (one diode voltage drop) above the 3.6 volts of the supply voltage. Second, clamping is done by a FET switch inside U1 that is connected from LXP (synchronous bypass arrangement) connects that pin to POUT and POUT1 which folds right back into 3.6. This basically charges capacitors C2 (220 uF 10 volt), C3 (220 uF 10 volt), and C4 (0.22 uF 10 volt). Note that two capacitors C2 and C3 in combination act as voltage (charge) storage capacitors for a 10 volt rated 440 uF capacitance which is the desired value but not readily commercially available and therefore two capacitors connected in parallel are used. A single 10 volt 220 uF capacitor, or other combination of capacitors may be used. Capacitor C4 is a very low value and is used to provide a high-frequency bypass to take edges off of the signal. C4 is optional and may be eliminated, however, the performance of the circuit is degraded somewhat.

Note that in this process, current has been directed through inductor L1, got the inductor charged up with energy, transferred the connection of the inductor L1 to the output capacitors C2 and C3 (and C4), and caused the energy to transfer to the output capacitors.

Note that low voltage at fairly high current has been used to charge storage capacitors. If this is repeated many times, the voltage will increase to a fairly high number unless some means or circuit is used to drain or otherwise control the accumulation of charge or voltage.

U1 terminal FB is a feedback pin. The voltage on the FB pin controls characteristics of the signal the directs the afore described switching of current through L1. The switching is altered in one or more of the timing, the shape of the waveform (pulse width modulation), that is used to control the power. For example, if the inductor L1 is turned on for less time it will have less power and ultimately has less power to put into the output circuit, and if not turned on at all will have no power to output. Therefore if the 3.6 gets to a desired level, and there is no draw, then the switching will turn off so that no further power is generated and the voltage on the storage capacitors C2 and C3 is maintained at the desired level.

U1 provides a reference REF (pin 1) that is established at 1.25 volts. The goal is to get FB to be 1.25 volts. If FB is less than 1.25 volts, then the circuit will try to put out as much energy as it can. If FB is higher than 1.25 volts it will stop putting out any energy. It knows the voltage produced by a voltage divider circuit comprised of R10 (10 ohms), R13 (294 Kohms), R14 (121 Kohms), and R15 (4.42 Kohms) and extending between the 3.6 volt supply and ground. Note that FB sees a voltage between the series combinations of R10+R13 and R14+R15 form a voltage divider. This voltage divider is set up so establish a voltage of about 4.2 volts. This chip tends to built the voltage to 4.2 volts so that is operation were strictly predicated on voltage, would attempt to achieve this voltage at the C2 and C3 capacitors. However, operation is not strictly predicated on voltage and there are a couple of other considerations that went into establishing the voltages.

First, the voltage is going across the Li-ion battery and its protection circuit. If the battery is discharged, down to the 3.3-3.4 volt area, and one puts 4.2 volts across it, then the battery will attempt to charge at a rate higher than it is supposed to charge. Instead, we look at the charging current sensing resistor R17 to build a voltage, and compare this first voltage to a second voltage developed by current flowing through resistors R24 and R15. The comparison is made by operational amplifier U2 (LMV921M7). Operational amplifier may conveniently be implemented with a LMV921M7 operational amplifier made by National Semiconductor.

If the voltage at the positive input of the operational amplifier exceeds the voltage at the negative input, then the operational amplifier output will increase and feed current to diode D2 (BAS16HT1), and satisfy a current need to keep the feedback point FB at 1.25 volts and require less current to come down through R10 and R13. Diode D2 may conveniently be implemented using a BAS16HT1 diode made by ON Semiconductor. Therefore the voltage of output of the U1 chip or set-point will be decreased down from 4.2 volts to the 3.5 volt range. This will lessen the tendency to charge (or overcharge) the battery.

It is noted that this presents a novel use of a chip (U1) that is normally used as a fixed voltage source, and implement some feedback in that would limit the voltage so that the current charging the battery would not be excessive.

Although the U1 chip includes a feedback pin, the use of the feedback input and the circuitry that generates the feedback voltage are different than might conventionally be used. Recall the use of operational amplifier U2 and resistor R16 and diode D2 in conjunction with the voltage across R17 and the voltage across the top of R15 within the serial combination of R14+R15 in the voltage divider circuit, effectively form a feedback control signal generating circuit that provides an input to the FB pin of U1. The voltage at R15 gets too high if too much current is flowing through the battery and the feedback will lessen this so that the battery is not overcharged. If on the other hand, somebody tries to use the phone creating need for transmit power rather than a standby type mode, the circuit will continue to try to put out more and more power at what ever voltage is convenient to try to keep the battery from being overcharged to supply the phone. The modulator will turn on for a longer time to try to supply the needs of the phone and to charge the battery.

A fuel-cell voltage divider circuit off of the fuel cell (extending between FC1 and FC2 at ground) comprised of R6 (10 ohm), R5 (9.53 Kohm), R4 (6.49 Kohm), R3 (16.9 Kohm), and R2 (127 Kohm). A tap at VDIV3 between R3 and R4 is connected to the Ain input (pin 6) of U1. This Ain or VDIV3 signal or voltage becomes a sampling of the voltage of the fuel cell. If the fuel cell voltage drops much below about 1.3 volts, this Ain pin will come up against the 1.25 reference voltage within U1. Ain is an amplifier input, and A0 will start to go up and detect that Ain is beginning to get to close to the reference point voltage. In response to this condition, A0 acting as a current sink, when it sinks current it starts to turn on transistor Q2 (MGSF1PO2EL). Q2 may for example be implemented with a MGSF1P02EL power MOSFET made by ON Semiconductor. Note that Q2 is in parallel to R13, which is a component of the earlier described voltage divider circuit. Operation of the transistor in conjunction with resistor R13 results in the feedback FB pin to be satisfied and stop trying to put out anymore power or voltage. The fuel cell can be controlled so that the fuel cell output voltage does not drop too far in voltage so as to maintain advantageous power curve relationship.

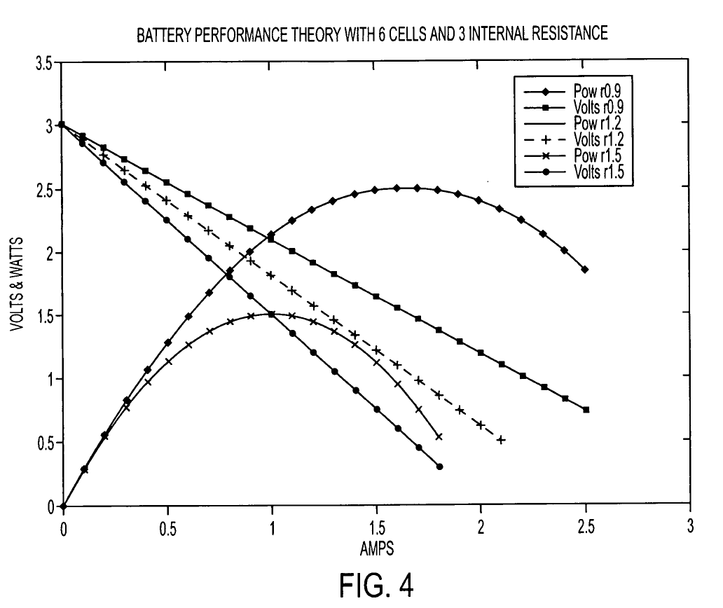

Diverging from the main discussion of FIG. 3, it is noted that FIG. 4, illustrates a typical fuel cell power output curve that generally is in the form of a pseudo parabola. It is desirable that operation be maintain on the left side of the peak and not on the downward slope to the right of the peak. Operation and control of the fuel cell is directed at achieving and maintaining operation in the desired region of the curve.

With further reference to FIG. 3, it is noted that the battery is essentially in parallel with storage capacitors C2, C3, and C4. If the circuit stops charging energy through U1 to charge C2, C3, C4 so as not to pull down the voltage of the fuel cell anymore, then if the battery has a higher potential it will discharge and supply energy to the phone. It is the equivalent of a logical OR, such that the voltage building circuit, storage capacitors, and battery are tiled together and the one that has the most energy at the time will supply the phone or other electronic device's power needs. Therefore battery supplies the energy if the fuel cells cannot provide it. During some operational modes, it is expected that the fuel cells, storage capacitors, and batteries may contribute power.

Note that in one embodiment of the invention the battery is physically smaller and has a smaller capacity that a conventional battery because the fuel cell effectively provides the additional power. For example, in some conventional cellular telephones, a Li-ion battery having a capacity of between 900-1600 amp-hrs may typically be provided. By comparison, a Li-ion battery having only a 300 amp-hr capacity is used with the fuel cell. Battery is smaller than normal because you would prefer to rely on the fuel cells. In some instances, the battery is needed to supplement power during typical high power transmit mode operation. The battery is then recharged from the fuel cell during standby operation.

Other embodiments, may use larger or smaller batteries, and in one embodiment the battery is very small, such as under 100 amp-hr and only used to buffer charging of the fuel cells. In yet a further embodiment, the battery is eliminated completely, being replaced by high capacity storage capacitors. Of course the need and or sizing of batteries and storage capacitors will depend upon at least the power requirements of the device and the required operating time, as well as the required operating duration in any high power consumption mode, and the acceptable recovery time.

Having now described the manner in which power or energy flows through the inventive circuit and is regulated, attention is now directed to aspects of processor or microcontroller U4 which performs additional control functions.

Processor or microcontroller U4 (ATtiny15L) operates primarily as a housekeeper, looking at the voltages, primarily at the fuel cell voltage, and deciding when to turn the converter U1 on and when to turn it off. Converter U1 has an ON pin 16 of the converter to make it run or to make it not run. If the processor U4 does not sense certain conditions it will not turn the converter U1 on. U4 uses the SVFC lead (U4 pin 3) which is a sample of the fuel cell voltage, to decide whether it should or should not operate the device.

During many phases of operation, processor U4 is not required as non-processor hardware provides sufficient control with the afore described feedback to maintain operation. Not operating processor U4 is advantageous when possible as it consumes very little power while in a sleep mode. Processor power saving conventions and sleep modes are known in the art and not described in detail here, but typically involve slowing or stopping a processor clock and/or lowering a processor core voltage.

Note that in the circuit embodiment illustrated, a variety of test pins (TP) and pogo pins (PG) are illustrated. These pins are conveniently provided for monitoring and testing circuits, particularly during prototype development, but are not required in a commercial embodiment of the circuit. Other pins are conveniently provided for loading software or revisions to software into the processor and the like. For example, an SDI pin is a serial data in pin that permits in-circuit programming of the processor. PG15 provides a lead for a serial instruction in line signal. PG11 provides a pin for a serial clock in signal. Other optional though desirable pins are shown in the figures.

Attention is now directed to processor, microprocessor, or microcontroller U4. The U4 processor is conveniently implemented with an ATMEL ATtiny15L microcontroller. This processor supports execution of commands or instruction that modify or control the operation of the processor.

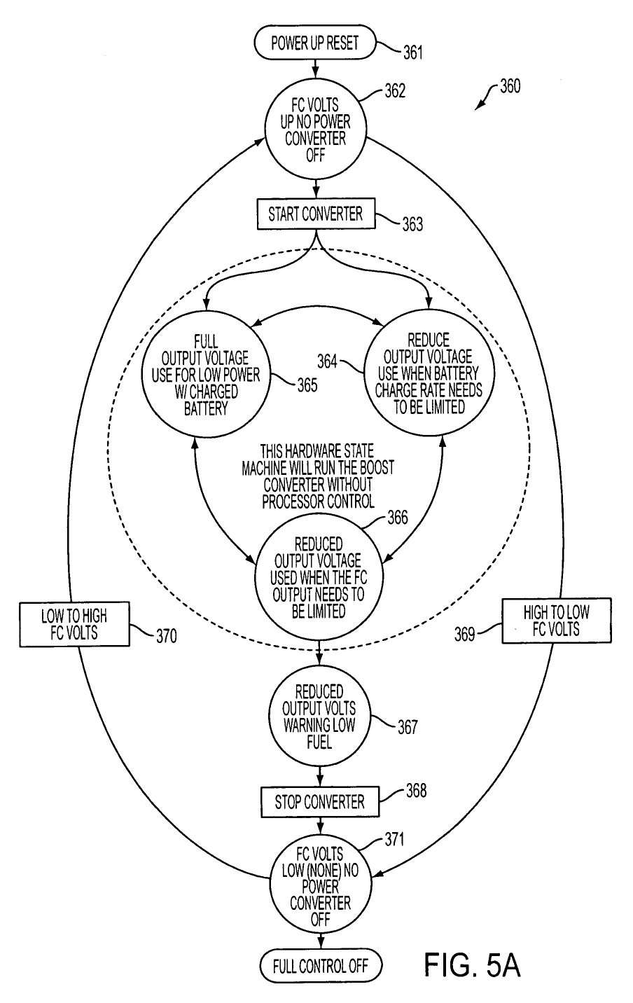

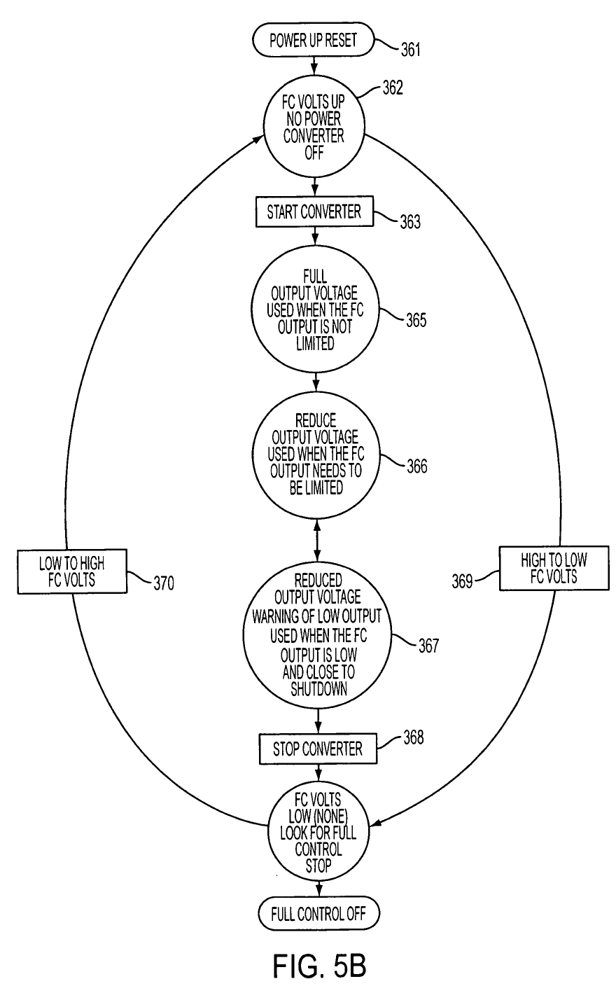

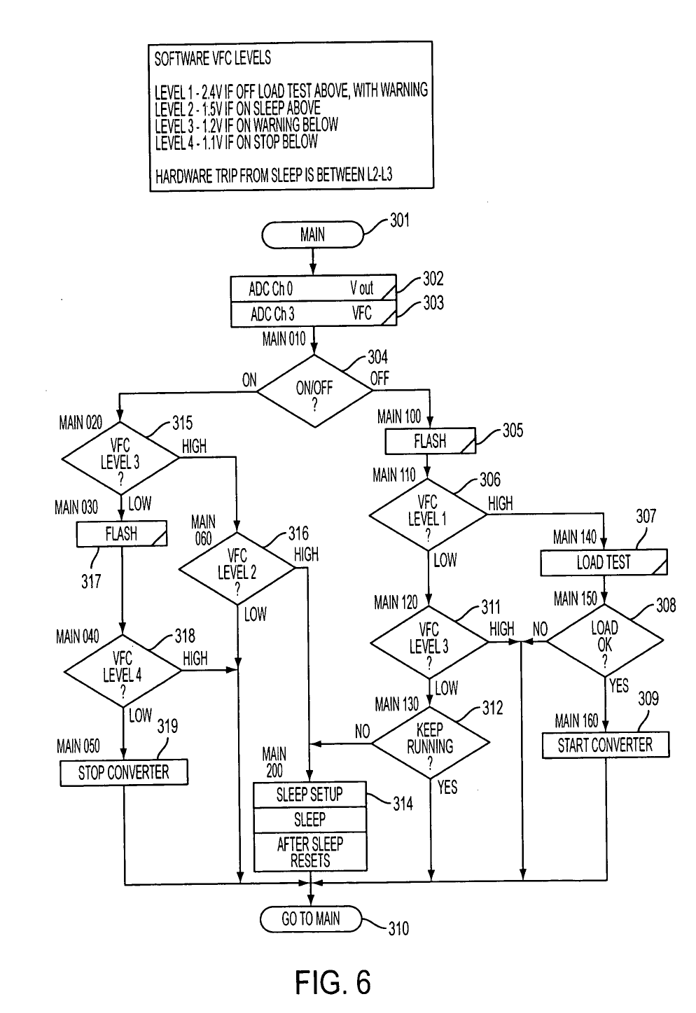

FIG. 5 shows exemplary state diagrams for operation of the inventive circuit of FIG. 3 in accordance with one embodiment of the invention including a Power-up reset routine 361. The state diagram in FIG. 5A is a variant of that in FIG. 5B as it includes additional state Reduce Output Voltage (Use When Battery Charge Rate Needs to be Limited) 364 during operation in Full Output Voltage state. These diagrams shows aspects of the invention in which a hardware state machine will run the boost converter without processor control.

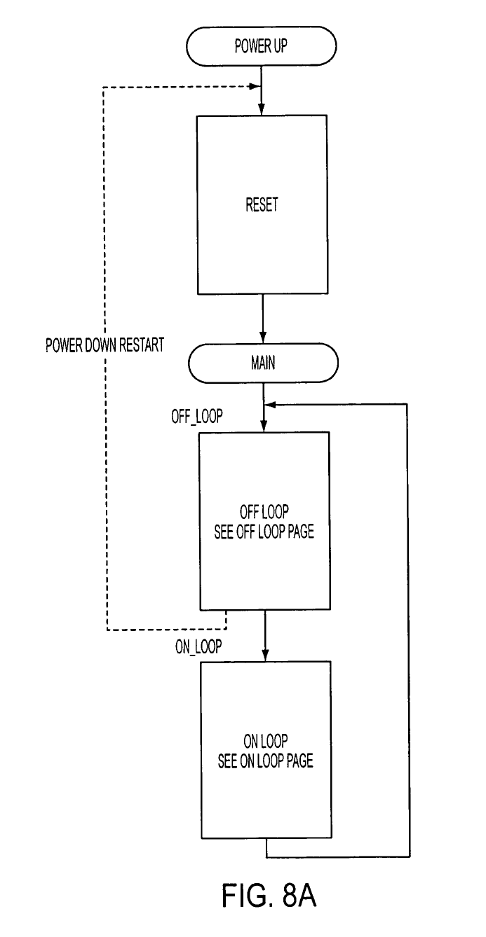

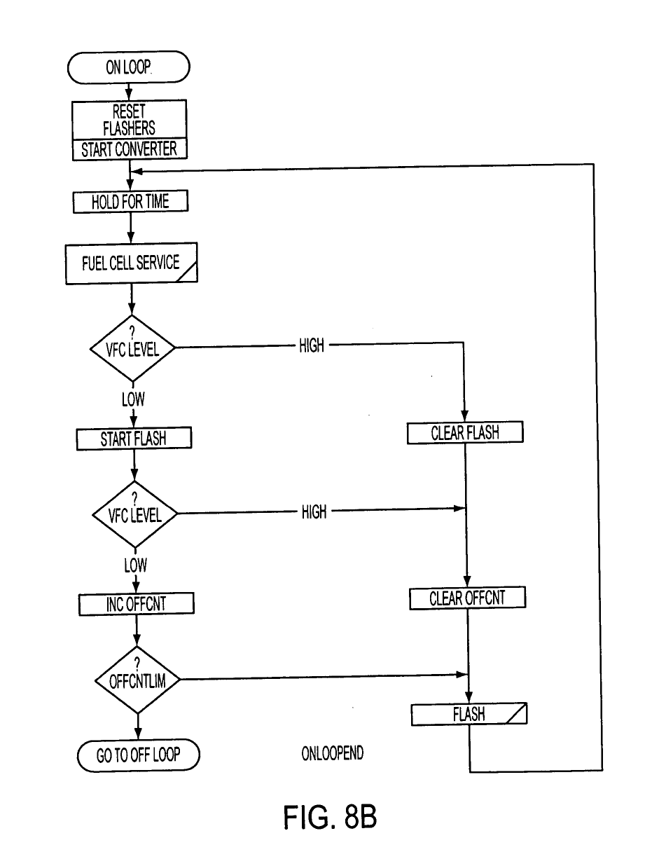

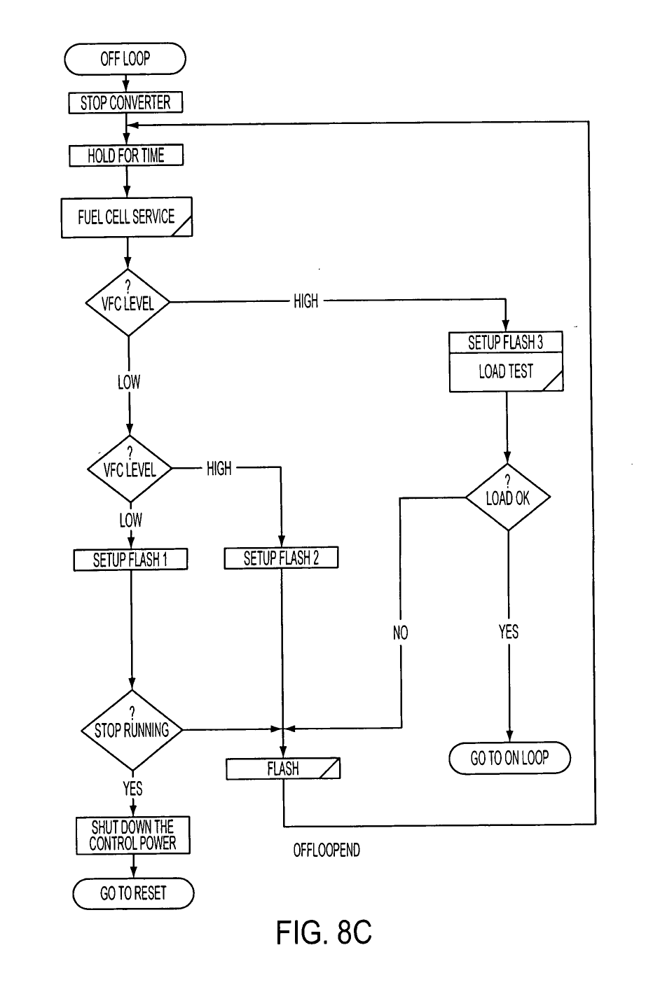

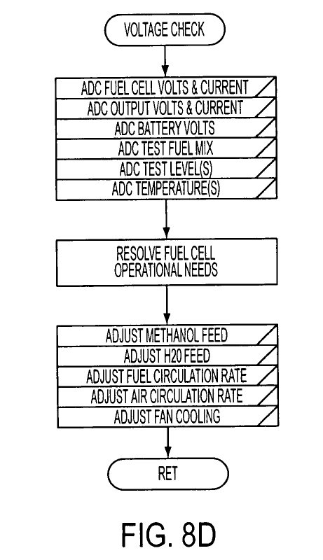

Attention is now directed to FIG. 8, which provides a diagrammatic illustration showing a computer program microprocessor or micro-controller implemented control scheme for controlling fuel cell operation in or with a laptop computer or other electronic device. It shows several control procedures including the showing main-loop, on-loop, off-loop, and Fuel Cell Service sub-procedures, for use in or with a laptop computer or other electronic device or system. Reset block 381 is a cold start system setup one-pass routine that is entered from power-up or other complete-start need or situation. It passes control to the Off block 382. Off block 382 is a routine to operate the fuel cell when the main converter is off. This will manage the fuel cell in a low power mode and look for any need that may arise to completely shutdown or go to the On block 383. On block 383 is a routine to operate the fuel cell in a high power mode when the main converter is on. This will manage the fuel cell and look for a need to stop the main output and return to the Off block 382. The Fuel cell service routine 384 checks the fuel cell operation and adjusts the pump rates to maintain optimum cell output performance.

Exemplary Embodiments of Control Procedures and Computer Program Instructions

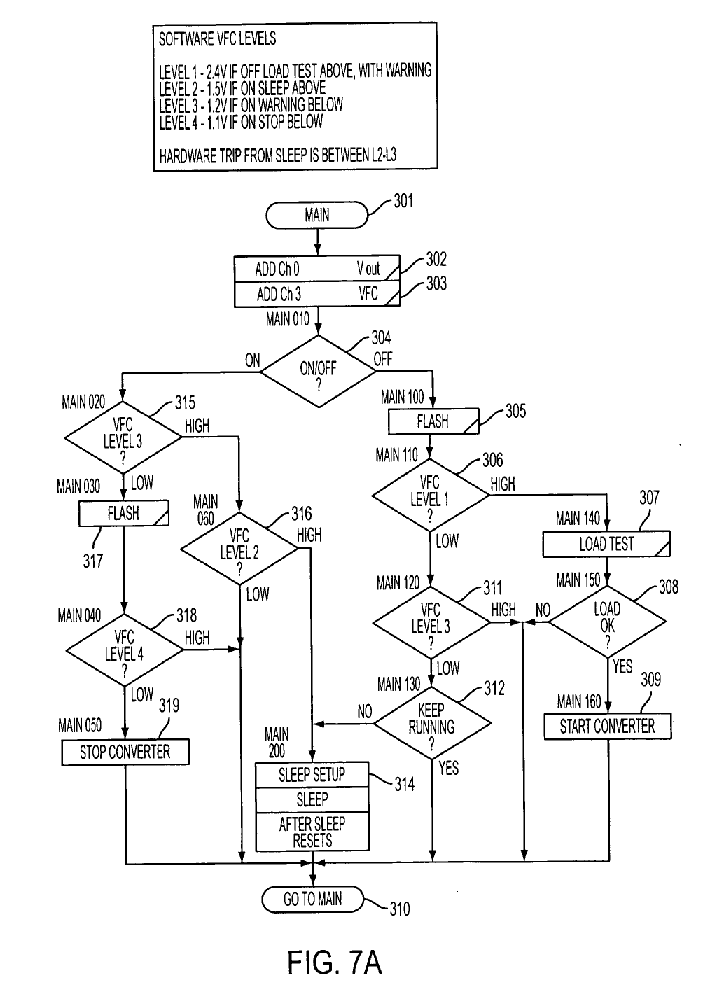

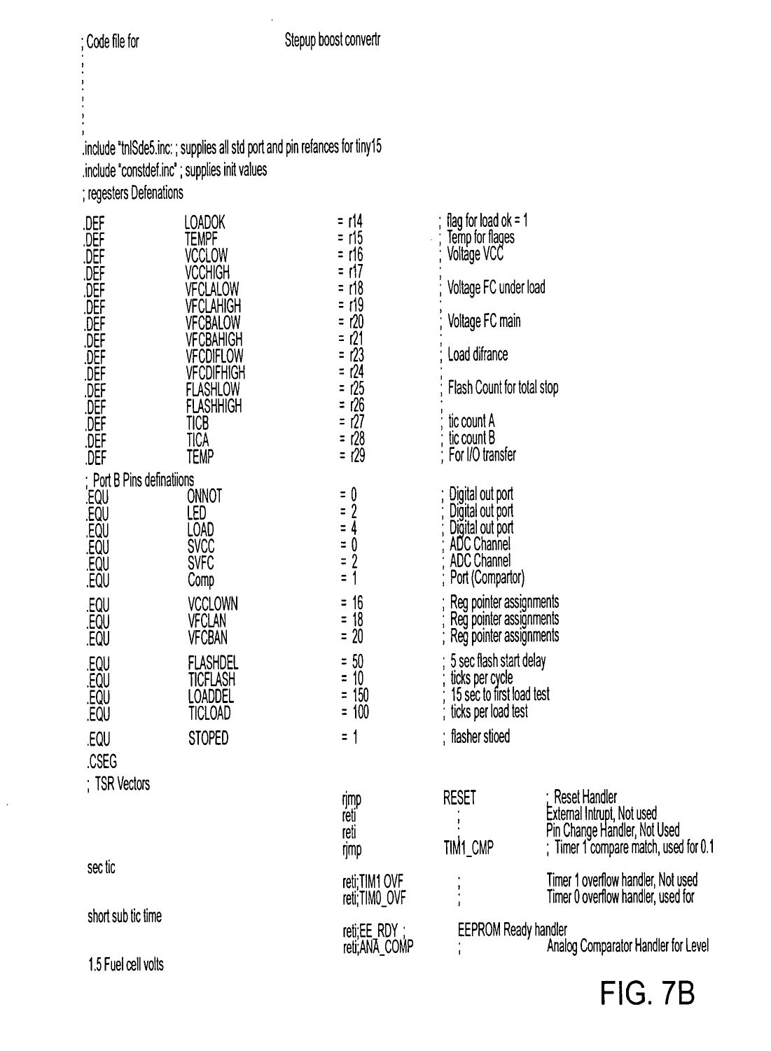

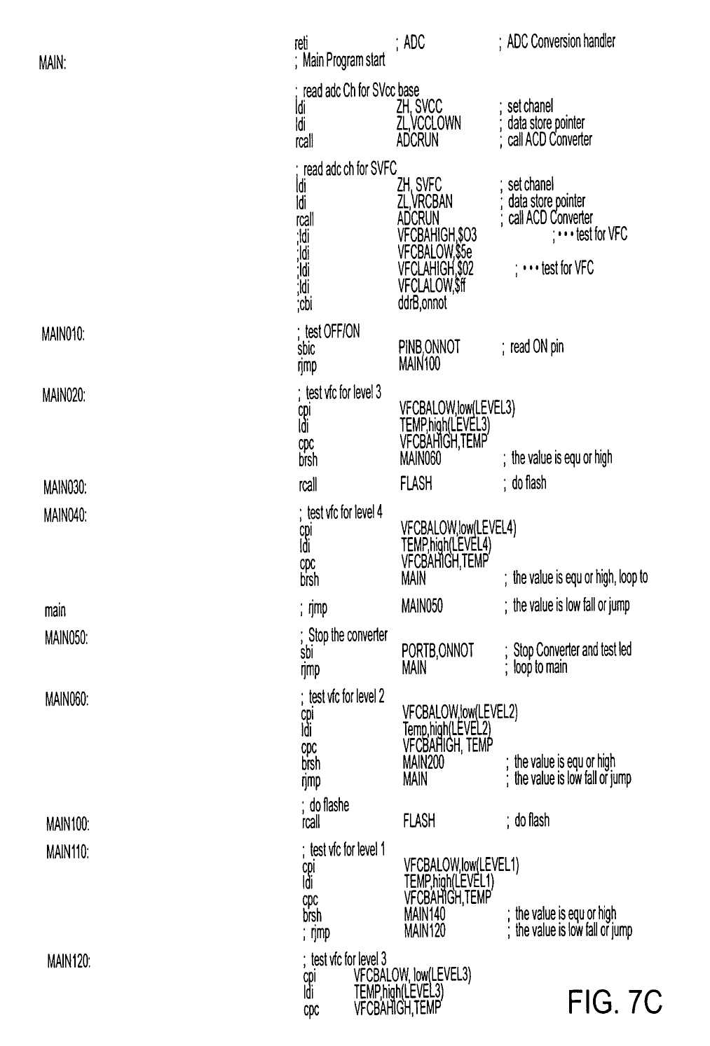

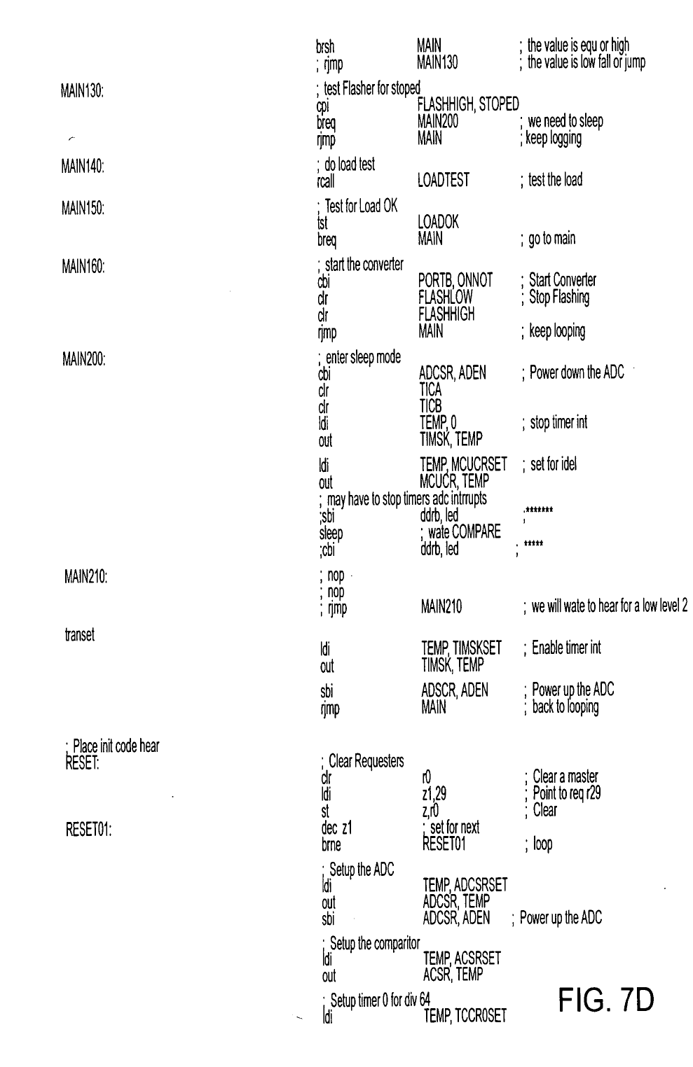

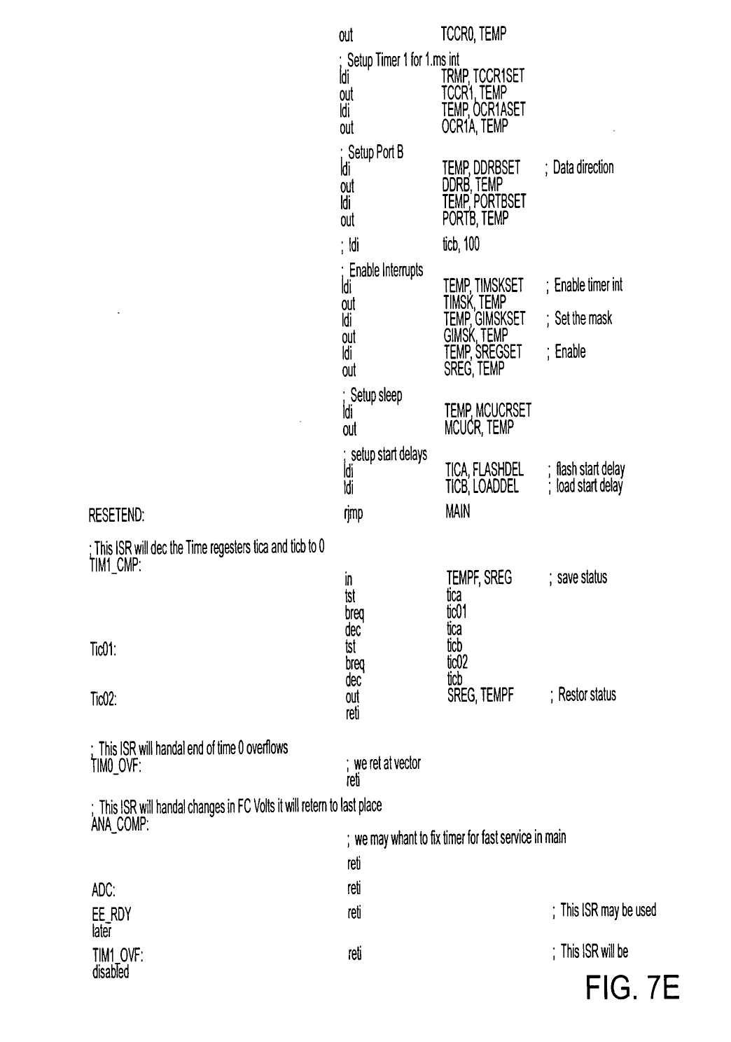

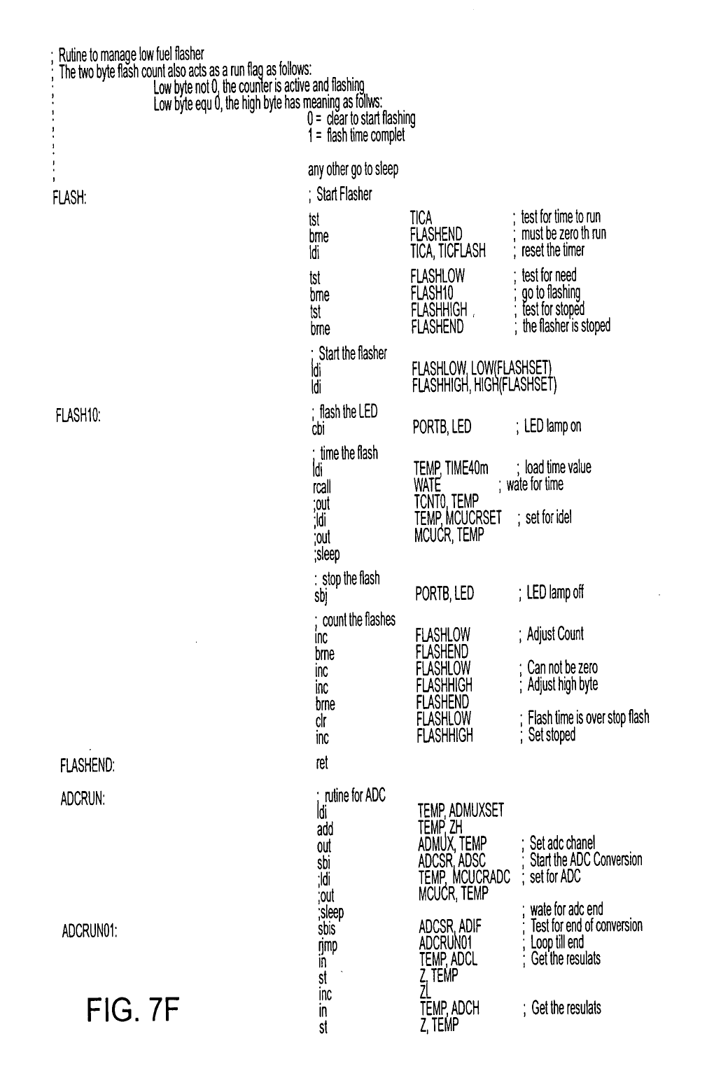

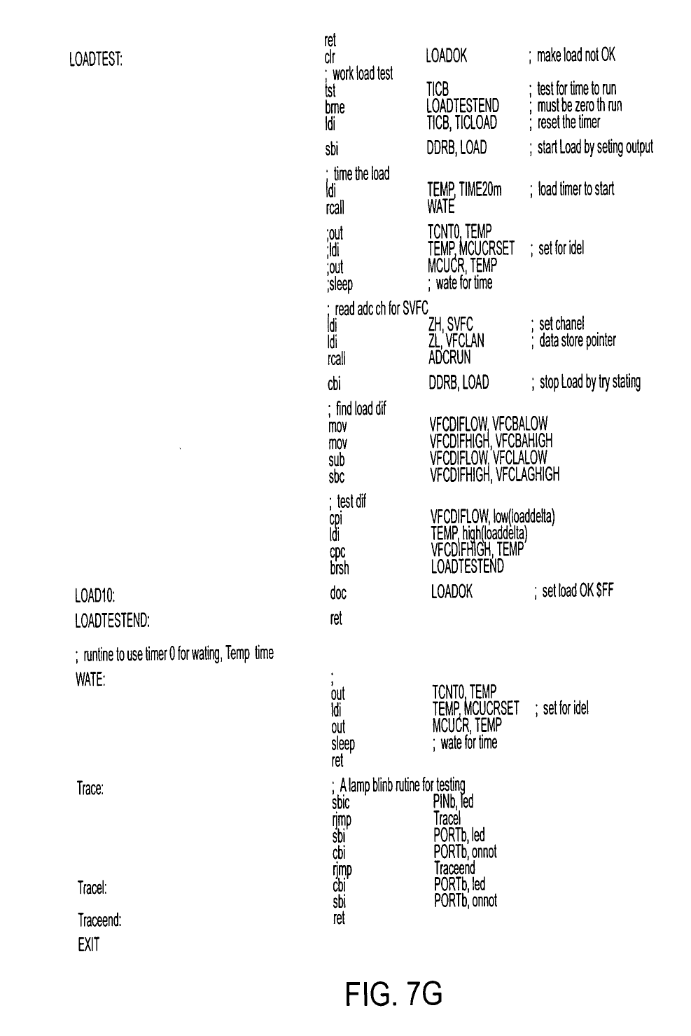

Several procedures implemented as software and/or firmware are now described relative to FIGS. 7-16. Means are provided to input the computer program code into the processor from ports provided on a printed circuit board on which components of the inventive circuit are attached, including processor U4.

Primary among the programs is a MAIN procedure or routine which executes continuously within the processor while it is in an active or awake state. The awake state may be achieved using a Comp signal (pin 6) which connects to a comparator in the processor that trips at about 1.35 volts. If it trips, it wakes up the microprocessor U4 so that the code begins to run. The hardware continues to run and generates an interrupt to wake up the processor.

An embodiment of the MAIN procedure or routine is illustrated in the flow-chart diagram of FIG. 7 is now described.

MAIN 301 begins after processor U4 initializes (INITS) itself and it jumps into its main flow loop and continues to execute this loop continuously while it is awake, that is until it enters sleep mode. Upon first executing MAIN, two voltage readings for Vout and VFC are taken and stored using the ADC routine. More particularly, ADC Channel 0 (Vout) 302 and ADC Channel 3 (VFC) 303 are performed, including measuring the voltages and converting them into digital numbers, and storing them in memory or register. These voltages are used in making further decisions as to the condition of elements of the system and any corrective action that may be required or desired. Note that the measurements are taken upon each execution of the main loop so that this monitoring is more of less continuous while the processor is awake.

Next, a determination 304 is made in MAIN010 as to whether the boost circuit U1 is in an ON state or an OFF state. (Note that “MAINXXX” refers to labels within the code but they are conveniently referred to as routines here where actually they are portions of the MAIN procedure.) ON and OFF conditions are described in turn below, beginning with the OFF condition.

If the boost circuit U1 is in an off condition, then MAIN100 is executed to Flash 305 the LED indicating a possible problem condition. Then a series of determinations or comparisons are made relative to the fuel cell voltage (VFC) as the answer to these queries indicate proper operation, operation that is problematic but that may be remedied, or conditions that suggest that a problem cannot be remedied. Four software VFC levels are used, and some modification of these levels may be accomplished under hardware and/or software control to fine tune operation of the system. Level 1 306 refers to a VFC of approximately 2.4 volts, level 2 316 refers to a voltage of about 1.5 volts, level 3 311 refers to a voltage of about 1.2 volts, and level 4 318 refers to a voltage of about 1.1 volts.

After flashing 305 the LED, the program determines if the fuel cell voltage VFC (MAIN110) is above (high) or below (low) the level 1 voltage (here 2.4 volts) 306. If the fuel cell voltage is above 2.4 volts (above level 1) without load, then MAIN140 is executed to perform a fuel cell load test 307 where an incremental load is applied to the fuel cell to see what happens to its output voltage. If the fuel cell has inadequate fuel to generate power (or has otherwise failed in some manner) it will not be able to maintain its output voltage and will fail the test. On the other hand if it is fueled and otherwise operational, the load test should be passed. If the load test is passed or OK, then the boost converter circuit is started or turned 309 on by routine MAIN160, if the load test was not completed OK, then the program returns to execute another loop of MAIN to start the process again. In either the case that the load test was OK or not OK, the MAIN loop is executed again, the fuel cell converter being turned on under one condition and not turned on under the other condition.

The load test 307 is performed to determine if fuel cell is capable of sustaining operation. Note, that the load test and/or the MAIN140 routine desirably has a counter in it so that the load test is not actually performed with each loop of the program which would result in load testing every few milliseconds, but rather the load test is performed every ten seconds or so when load testing is appropriate.

If when performing MAIN110, the fuel cell voltage was determined to be lower than level 1 (2.4 volts), then the MAIN120 routine is executed and a determination 311 is made as to whether VFC is above or below the level 3 voltage (1.2 volts). If the inquiry and comparison indicates that VFC is above Level 3, then no action is taken and MAIN is executed again. However, if VFC is below Level 3, then the MAIN130 routine is executed making an inquiry 312 as to whether the processor U4 should keep running or place itself into a power-conserving substantially inactive sleep mode. The processor may be programmed in various ways to provide for either continued monitoring and attempts to operate the fuel cell to generate power (that will consume power at a faster rate) or to place the processor into a sleep mode thereby conserving power until the fuel cell is refueled or other corrective action is taken. In one embodiment, when VFC is below a level 3 voltage threshold, the processor is placed into a sleep mode until triggered to wake up by a hardware comparator trip circuit at a voltage somewhere between level 2 and Level 3. Therefore, in at least one embodiment, if VFC is below level 3 then the MAIN 200 routine is executed to place itself into a sleep mode 314 since it cannot recover from the then fuel cell condition. MAIN200 provides procedures and functions that setup the processor for sleep, maintain a low power consumption sleep mode, and reset the processor after the processor resumes from sleep. If no corrective action is taken to restore fuel cell operation, such as by refueling, eventually the processor or microcontroller U4 will stop because there is no voltage to even operate it.

Returning to execution of MAIN010, if fuel is present or fuel is provided after the processor went into the sleep state and then resumed from sleep state after a corrective refueling, the state of the boost converter circuit may be on but more typically will be off. The initialization routine will place the boost converter into an off state so that it will be in an off state when it is first put into service. If for some reason the processor goes into a sleep state when the boost converter circuit is in an on state then it will still be on when and if the processor U4 wakes up again. If processor sleep is caused by running out of fuel and for example, enters from MAIN130 (boost circuit was off) then it will still be off. These various situations and the state of the boost circuit when resuming or awakening from sleep are illustrated in the diagram as in general the boost circuit will be in the state it was in when the processor went to sleep or will be off. Returning to execution of MAIN010, MAIN020 determines 315 if VFC is above or below the level 3 voltage. If VFC is above level 3 (high), then the MAIN060 routine determines 316 if VFC is above or below the level 2 voltage. If VFC is above both 1.2 volts (Level 3) and above 1.5 volts (level 2) then the program executing within the processor decides that operation of the fuel cell and boost circuit are sufficiently stable that it does not need to monitor or act and executed MAIN200 to place itself into a sleep mode 314, as already described. Note, that although the processor could remain active this would consume power for a housekeeping type function that is not required. Recall that during a certain range of operating parameters, hardware components are provided that include feedback control elements to control and regulate operation of the boost converter circuit and other elements of the inventive interface and control circuits.

Returning again to the comparison performed by MAIN020 to determine 315 if VFC is above or below the level 3 voltage, if the determination 315 indicates that VFC is below level 3 (low), then routine MAIN030 causes the LED to flash 317 indicating a problem condition. The number or duration of flashing may be selected to suit operational preferences and a desire to conserve power. Next, routine MAIN040 compares 318 VFC with the level 4 voltage (1.1 volts). If VFC is above level 4 (high) then the program returns to MAIN and executes the loop again, the voltage still being sufficient to support operation. However, if VFC is below level 4, routine MAIN050 is executed to stop the boost converter U1 319 as under this condition it appears that the fuel cell has insufficient fuel to generate even a minimal voltage or there is some other problem. When the next loop of MAIN is executed, the boost converter circuit will be in the OFF state and MAIN will execute beginning with MAIN100 as described herein above.

FIG. 7 provides a listing of exemplary computer code suitable for operation in the U4 processor generally corresponding to the description in the referenced flow-chart diagrams, including in MAIN and in routines called by MAIN. Attention is now directed to descriptions of several miscellaneous routines and the flow-chart diagrams in the figures that are called by or referenced within MAIN.

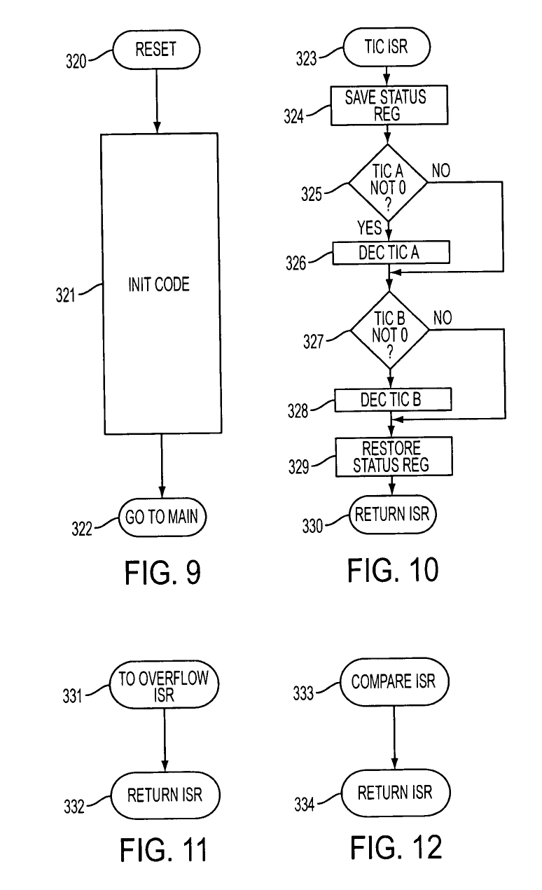

The Reset routine 320 (See FIG. 9) executes when the processor is first started, such as during power-up, and initializes the processor and by virtue of the processors connections to other components of the interface and control circuit, initializes and resets the circuit generally.

The Time Clock Interrupt Service Routine (TIC ISR) 323 (See FIG. 10) is set up to generate an interrupt in some predefined time increment, such as a 0.1 second increment and generate a count of such increments, and these increments are counted until a desired time is obtained. In general, a count is placed in a memory storage or register and the count is decremented to zero. This reduces the number of comparisons that are needed to determine if the desired time has expired. Conventional up counters may alternatively be used but are not preferred. For example, to provide a 10 second timer, 100 of the 0.1 second clock pulses are counted. TIC ISR is used for example by the Flash routine described below to control flashing of an LED. The TIC ISR is executed in response to receipt of an interrupt. The TIC routine has two routines so that separate counters may be used, TIC A and TIC B. Status is saved in a register, then a determination is made as to whether the Time Clock A (TIC A) is zero or not zero, if it is not zero meaning there is a value stored there, then the TIC A counter is decremented, and then TIC B is tested to determine if it is zero in analogous manner. If TIC A was zero, TIC B is tested in the same way. In other words, the TIC ISR basically says that there has been an interrupt, decrement the counter if the counter has something in it (e.g. non-zero contents) otherwise do nothing, restore status, and go back to the place in the code where you were when you received the interrupt. A single Time Clock may be sufficient in many circumstances.

The Timer 0 Overflow Interrupt Service Routine 331 (T0 Overflow ISR) 331 (See FIG. 11) is a simple interrupt service routine in that the mere fact that the interrupt occurred and was handled by this ISR is sufficient to accomplish its purpose. Therefore there are no instructions within the T0 Overflow ISR.

The Compare Interrupt Service Routine 333 (See FIG. 12) wakes up the processor from a power conserving sleep mode. This is an interrupt function, when an interrupt is encountered in the processor, there are eight vectors at the top of the code that can be set up to send various pieces of code, (See code in FIG. 7) which show ISR vectors. The compare ISR causes the processor U4 to come away and execute the next instruction from the point where it was sleeping. This means that it will resume and execute instructions until it goes to sleep again. For example, see Sleep block in MAIN200 for the location of the point where the processor enters sleep and resumes from sleep.

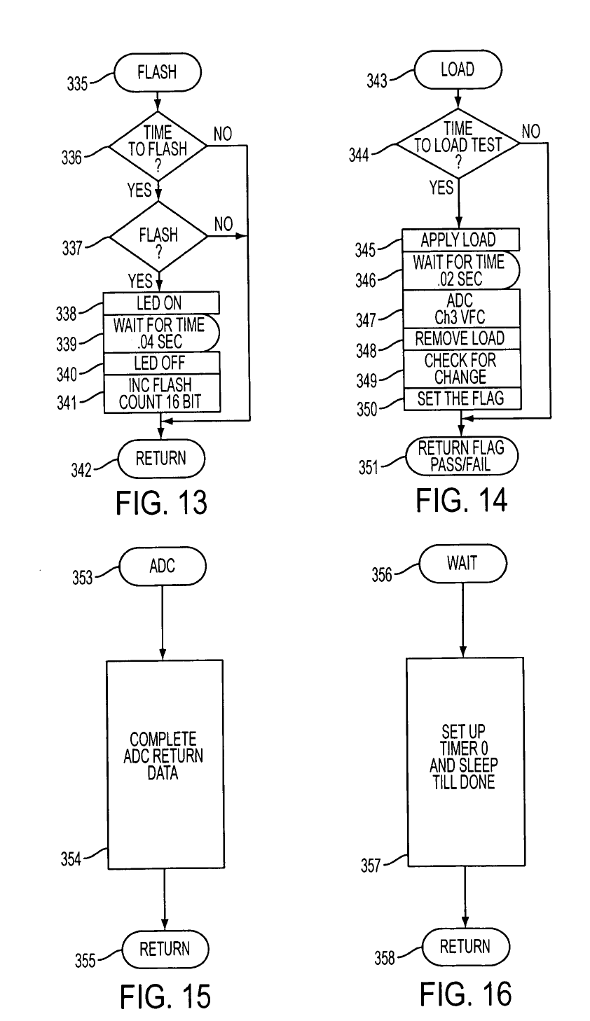

The Flash routine 335 (See FIG. 13) is used in a couple of places in MAIN, is concerned with how flash works. Flash is called whenever MAIN comes to a Flash routine. Flash asks if it is time to flash yet and looks at its TIC counter to determine if it is zero or not. If it is not zero, it goes back without doing anything, that is it does not flash, but if it determines that it is time to flash, it flashes (unless there is another condition that precludes it from flashing.) The LED is turned on for a predetermined period of time (e.g. 0.04 sec), then turned off. The flash counter is then incremented. Desirably, the duration that it flashes is limited so that if no one sees the flashing within some predetermined number of flashes or period of time, the flashing will stop so as to minimize power consumption.

The Load Test routine 343 (See FIG. 14) is a routine or procedure that load tests the fuel cell. A determination is made as to whether it is time to load test the fuel cell, if it is not time, the routine returns without testing. If it is time to load test the fuel cell, then the routine applies a load to the fuel cell, waits a period of time (e.g. 0.02 sec), read ADC voltage on Channel 3 for VFC, removes the load, check for a change in VFC to see if the fuel cell passed or din not pass the load test, a sets up a flag indicating the status of the test (passed or not passed), and then returns.

The Analog to Digital Converter (ADC) routine 353 (See FIG. 15) is responsible for reading a VFC voltage, converting it to a digital value or number, and returning the number to the requester. ADC may typically read the Vout and VFC voltages within the MAIN routine.

A Wait routine 356 (See FIG. 16) is implemented as a quick subroutine to hold until event is completed. This is accomplished by setting up Timer 0 and sleep until done.

Description of Embodiments of Exemplary System Hardware and Control Thereof

Attention is first directed to characteristics of the fuel cell or fuel cells arranged as a so called fuel cell “stack” and fuel cell stack components that provide support for or interoperate with the fuel cell stack.

In one embodiment, the stack of fuel cells has an output voltage in the range of from about 12 Vdc to about 30 Vdc, other embodiments provide higher or lower voltage output that may generally be dependent upon the structure of the fuel cells, the number of fuel cell stacks, their connectivity, and the desired output voltage and current characteristics. Other embodiments may therefore provide output voltages nominally at 3-5 Vdc, 6-12 Vdc, 13-15 Vdc, 24 Vdc, at voltages greater than 30 Vdc, or at other voltages as desired. Output voltage may also be somewhat dependent on loading.

Desirably, the stack should produce greater output power than would be required for operation of the device to cover the control and conversion efficiency needs. For example, providing or being able to provide 10%, 25%, 50% or some intermediate value may be desirable. In practice a value of 25% more power, or 125% total output power, represents useful value but ranges of power to cover the control and conversion efficiency needs may alternatively be provided depending upon system configuration, operational needs, and other factors.

At least some embodiments of the invention provide stack operation that requires, or in some embodiments, at least benefit from certain support components. Other embodiments, some of which are described in greater detail hereinafter, do not require all of these components. Parenthetic voltage levels are for a particular embodiment and it will be appreciated by workers having ordinary skill in the art in light of the description provided here, that components with different operating voltage (and/or current) characteristics may be used. In particular, components having operating voltage (and/or current) characteristics will typically be selected to be within the voltage (and/or current) producing range of the fuel cells. The operating voltages for the components are therefore exemplary of a particular embodiment and some components though advantageously provided are optional. It will also be appreciated that different components be selected to operate and completely different voltages and that appropriate voltage conditioning circuitry may then be provided to achieve the desired set of voltages. These support or interoperating components hare listed here and described in additional detail hereinafter: (a) a fuel mixing chamber; (b) an exhaust vapor recovery condenser; (c) an H₂O reservoir; (d) a methanol fuel reservoir; (e) a methanol metering pump (12 Vdc) implemented in one embodiment by a solenoid pump; (f) an H₂O feed pump (12 Vdc) implemented in one embodiment by a micro-diaphragm pump; (g) a fuel mix delivery pump (12 Vdc) implemented in one embodiment by a micro-diaphragm liquid pump; (h) one or more air circulation pump or pumps (12 Vdc) implemented in one embodiment using micro-diaphragm liquid pump(s); (i) one or more cooling fan or fans (12 Vdc) implemented in one embodiment with micro-diaphragm air pump(s); (j) a fuel mix sensor; (k) one or more temperature sensors (one embodiment provides four temperature sensors to sense and generate signals for temperature sensitive processes or devices); (1) one ore more level sensor (one embodiment provides three level sensors to measure the levels of different fluid reservoirs or tanks, such as the H₂O and methanol reservoirs.

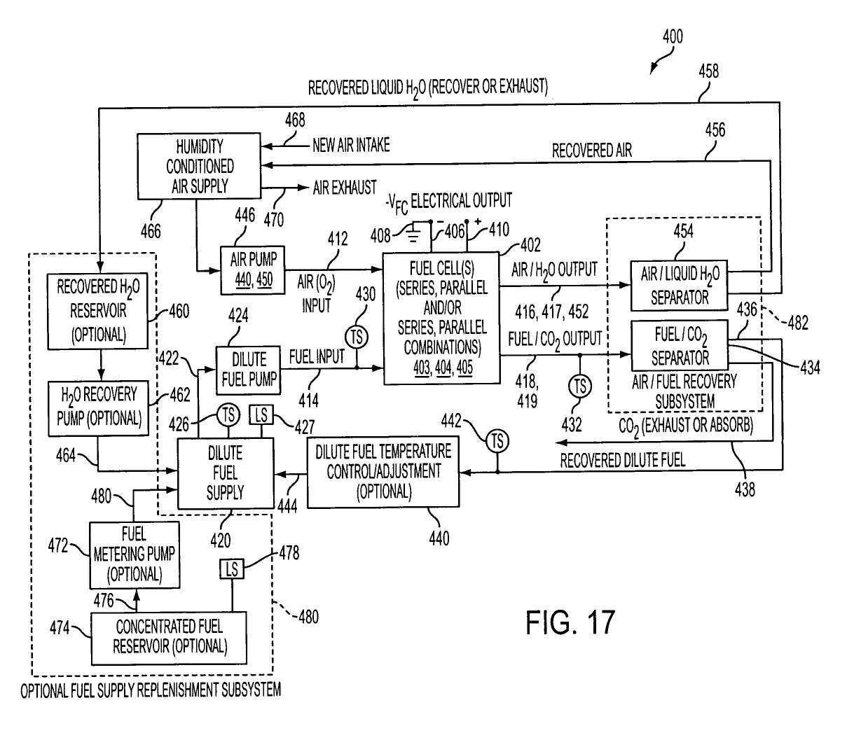

With reference to FIG. 17, there is illustrated a functional block diagram of a somewhat more elaborate embodiment of a fuel cell based system 400 for generating electrical energy (voltage, current, and power) from one or more fuel cells including for example from a parallel, series, or parallel/series combination or array of fuel cells. In this system 400, one or a plurality of fuel cells 402 receives a fuel mixture, such as a liquid fuel 414 and air 412 including an oxidizer 415 such as oxygen (O₂). In one embodiment, the liquid fuel comprises a mixture of methanol and water. In one embodiment of the fuel cell 402 operating on a methanol and water mixture, the air 412 and dilute methanol/water fuel 414 are pumped into or otherwise flowed through the fuel cell(s) and output as a combined air 216 plus water vapor (H₂O) 217 output, and a fuel 418 plus CO₂ 419 output, where the H₂O 417 and CO₂ 419 represent fuel cell reaction exhaust products. The air input 412, fuel input 414, air plus H₂O 416, 417 output, and fuel 418 plus CO₂ 419 output are coupled between the fuel cell(s) 402 and external components using tubes, channels, or other fluid and gas coupling devices and methods as are known in the art.

Operation of the fuel cell 402 results in generation of a fuel cell electrical voltage (V_{FC}) 403, electrical current (I_{FC}) 404, and electrical power (P_{FC}) 405, between or across first and second terminals 408, 410 to which may be coupled an electrical load 411. Details of open circuit voltages, voltage under load, or other details of voltage, current, or power of the fuel cell are described elsewhere in this description.

Fuel cell 402 may be any fuel cell or combination of fuel cells. As the maximum output voltage and/or current characteristics of a particular fuel cell may be limited, it will frequently be required to provide a plurality of fuel cells electrically serially coupled to provide a desired output voltage. Furthermore, as the current supplying capacity of a single fuel cell may be limited, it may similarly be required to configure a plurality of fuel cells in an electrically parallel configuration. Therefore the fuel cell(s) block may generally include any series, parallel, or series/parallel combination to obtain the desired voltage, current, and output power characteristics. In addition, it may be desirable or required to provide multiple ones (multiple stacks) of these series, parallel, or series/parallel combinations so as to provide a desirable operation from the perspective of fuel and air (or oxidizer) provision, operating temperature, chemical fuel cell reaction kinetics, and/or other operational factors.

Embodiments of fuel cells are described in attachments to this patent application and to patent applications and other references identified or described herein, each of which is incorporated by reference.

One particularly advantageous embodiment of a fuel cell for use in conjunction with a portable cellular telephone utilizes stacks of cells, that is capable of generating the voltage, current, and watts of power required to operate the cellular telephone.

A different embodiment of the system 400 for use in conjunction with a higher power device such as a portable notebook computer utilizes two stacks of cells, that is capable of generating higher volt and power, for example voltage in the 10-10 volt range and power at least on the order of 25 watts of power. Additional cells may be combined to provide the desired or required voltage, current, and power performance levels.

Attention is now directed to structure and operation of the system 400. By the term dilute fuel we mean a mixture or concentration of the fuel that is less than 100% of the fuel with one or more additional components. In one particularly advantageous embodiment, the dilute fuel is a dilute methanol plus water mixture. Particular exemplary ranges for methanol and water are described in the other applications incorporated by reference herein.

Dilute fuel (for example, methanol plus water) is stored in a dilute fuel supply reservoir 420 and pumped using a dilute fuel pump 424 or otherwise flowed to a fuel input port of fuel cell 402. Where a plurality of individual fuel cells or fuel cell stacks as they are commonly referred to are utilized, a single pump may be used to supply all of the fuel cells or fuel cell stacks using suitable distribution plumbing or a plurality of pumps may be utilized to pump the fuel into and through the fuel cells. Where typically the number of pumps may match the number of fuel cell stacks, the number of dilute fuel cell pumps may be greater than or less than the number of fuel cell stacks, the number depending on the operational requirements and operating characteristics of the fuel cells.

Fuel cell(s) 402 also require an oxidizer for the fuel, easily and cheaply satisfied by air containing its normally occurring constituent gasses including oxygen. This air desirably has a humidity appropriate to maintain fuel cell membrane operating characteristics.

Air 412 having the desired humidity is pumped by air pump 446 from a source of such air that for example has been subjected to some humidity conditioning device 466, such as may be provided by a humidity exchanger, into the fuel cell 402.

The humidity conditioning device 466, such as the humidity exchanger may receive fresh new air at atmospheric conditions from a new air intake port 463 and exhaust air at an air exhaust port. The exhausted air may either be a portion (or all) of air recovered from the fuel cell or a portion (or all) of mixed new air and recovered air. (Recovery of air and removal of liquid water from the fuel cells 402 is described hereinafter.)

The fuel and air inputs react over a membrane based fuel cell reaction chamber generating a potential voltage difference across anode and cathode poles of the individual fuel cells making up fuel cell stacks where present and/or across fuel cell stacks. The final fuel cell voltage (V_{FC}) may depend upon the chemistry associated with the individual fuel cell elements or reaction chambers, the number of such fuel cell elements or reaction chambers, the connectivity of the fuel cells in to series, parallel, and/or series/parallel combinations.

In one embodiment of the fuel cell 402 having two stacks, each stack having fuel cell elements or reaction chambers, and operating with a chosen methanol:water ratio, the open circuit voltage across the fuel cell is set at a predetermined voltage or voltage range.

Fuel cell exhaust products are recovered from the fuel cell and where possible and economically or otherwise viable from an economic and/or environmental sense are recovered and reused. For example, in the methanol/water system, the fuel cell 402 outputs an air 416 plus water 417 mixture on one side of the fuel cell membrane and a methanol/water 418 plus CO2 419 output on the other side of the membrane. The air plus water mixture is passed through an air/liquid water separator 454. The recovered air is directed to a humidity conditioning device, such as to a humidity exchanger before being re-circulated to air pump 446 and back to the fuel cell 402. As already described, new air 463 may be introduced and recovered air or a mixture of recovered air and new air may be exhausted to obtain the desired air humidity characteristic. An air supply reservoir may optionally be provided or the air reservoir may be eliminated relying on the various tubing, channels, and conduits between the output of the fuel cells and the air pump 446 to act as a reservoir.

Air/liquid water separator 454 also provides liquid water which may either be exhausted from the system 400 or recovered and reused. Recovery of liquid water is particularly advantageous when the system is provided with fuel supply replenishment subsystem 410 described hereinafter.

Recall that in addition to the air input to the fuel cells, fuel is also input, and the fuel cell outputs a mixture of methanol/water plus CO₂. This mixture is passed through a fuel/CO₂ separator 434 which separates or removes CO₂ from the recirculating dilute methanol/water mixture. The CO₂ may either be exhausted 438 to the environment. The recovered dilute methanol/water mixture is then optionally but desirably processed to achieve a desired temperature range (usually by cooling) before adding it back to the dilute fuel supply tank 420.

Once the recovered methanol/water mixture has been recovered to the dilute fuel supply tank it is available to pump back to the fuel cell 402. (In the event that the system 402 is not configured to provide for fuel replenishment, such as when operating from a fixed volume of fuel mixture until that volume is consumed, a methanol/water separation device or drier may be used to extract water from the recovered fuel so as to minimize alteration of the desired methanol/water ratio.

Operational life of the system 400 between fuel cell 402 refueling events is advantageously extended by providing a fuel supply replenishment subsystem 480. A concentrated fuel reservoir 474 stores a concentrated fuel (such as a high concentration of methanol, for example pure or nearly pure or undiluted methanol). As the volume or concentration of methanol in the dilute fuel supply tank 420 drops, a pump, such as a fuel metering pump 472 pumps high concentration methanol into the dilute fuel supply tank to maintain or reestablish the desired ratio of methanol to water, and recovered water 458 is similarly pumped from a recovered water reservoir 460 by a water recovery pump 462 into the same dilute fuel reservoir. Various methods and systems may be used to determine the replenishment of high concentration methanol and/or water, such as those based on predicted consumption over time, measure or monitored concentrations in the dilute fuel supply tank, output of one or more fuel cells, or other concentration sensors (CS), and tank level sensors (LS). In addition, temperature sensors (TS), typically in the form of thermistors are used to monitor conditions within the system 400.

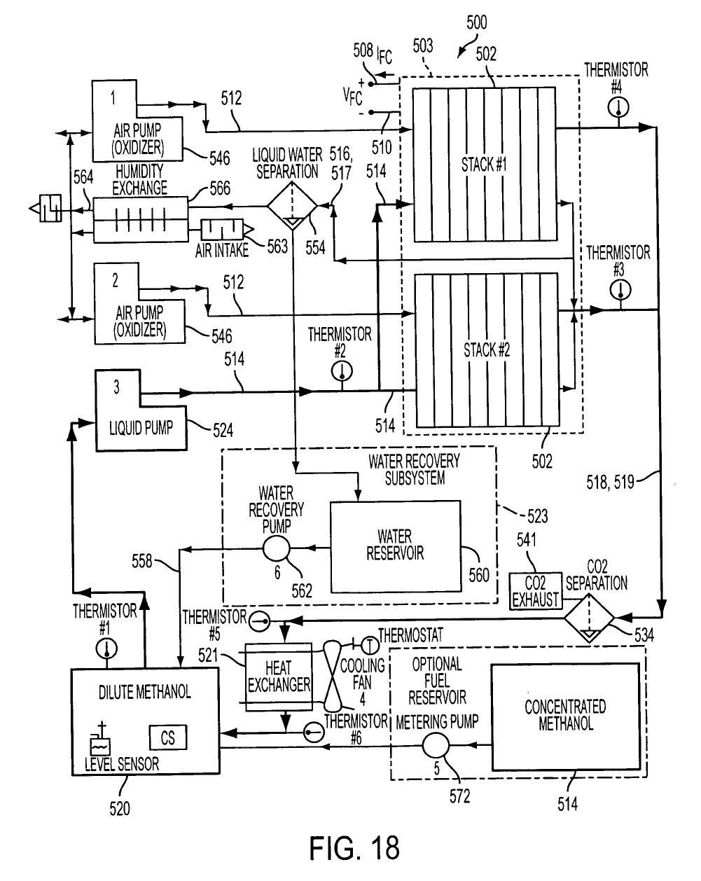

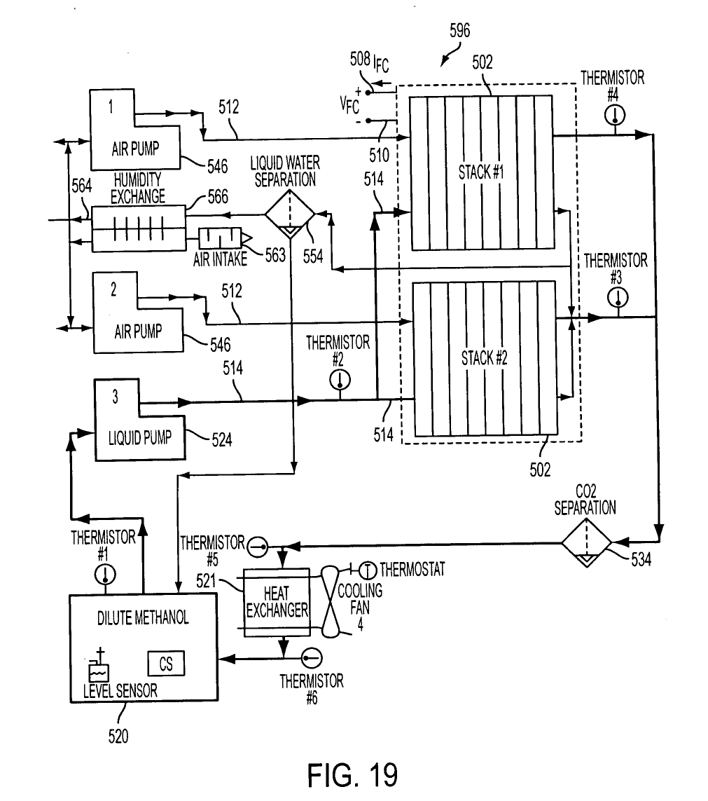

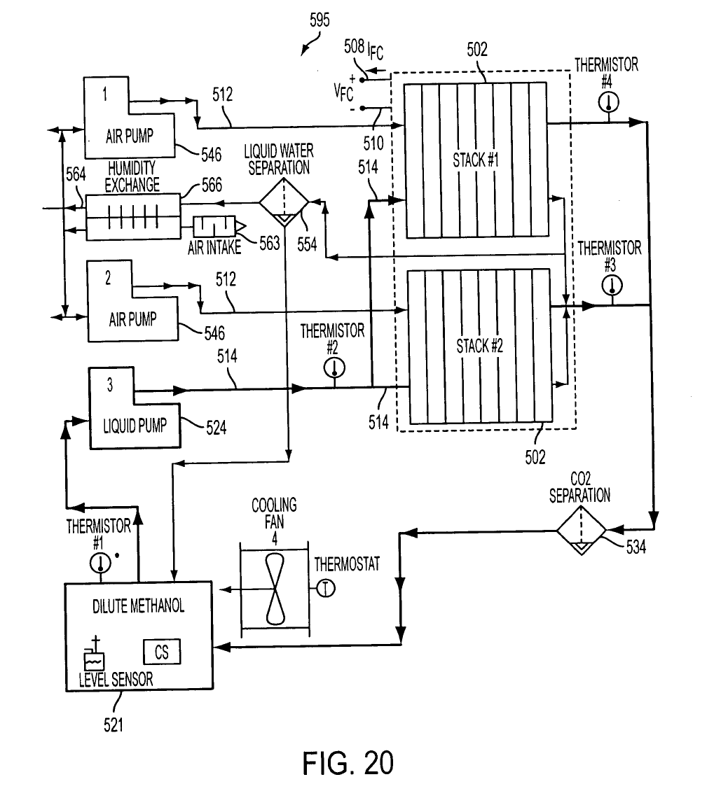

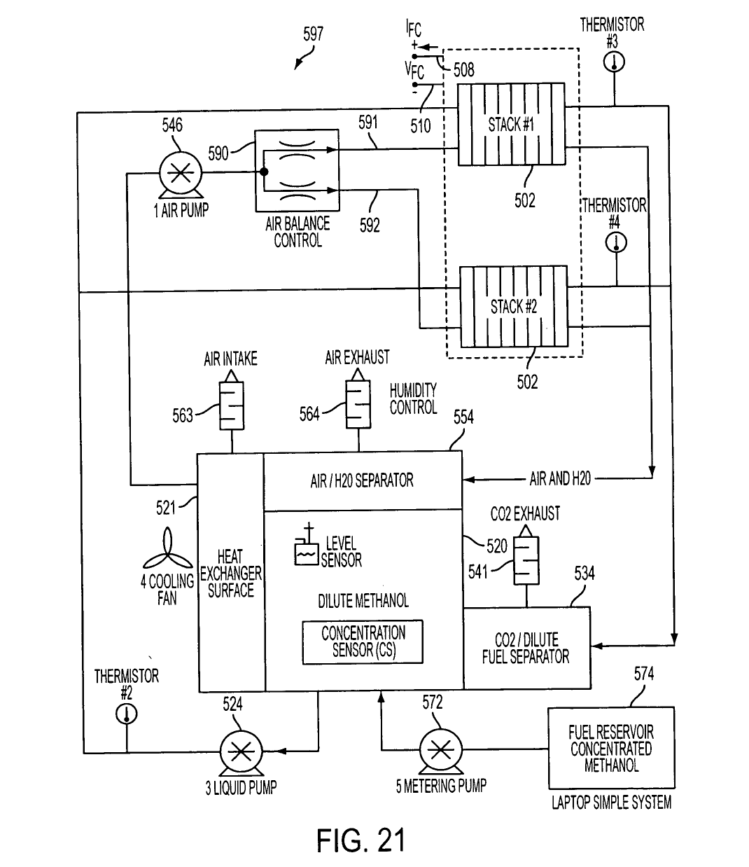

FIG. 18 shows an embodiment of embodiment of fuel cell powered electrical or electronic device such as an information appliance, PDA, or laptop computer. A comparison between the components and connectivity of the components of the FIG. 9 system block diagram and that in FIG. 3 will reveal some common features as well as some differences. This is also true of the FIG. 18, FIG. 19, FIG. 20, and FIG. 21 systems embodiments. This description will therefore rely somewhat on the description provided relative to an embodiment corresponding to FIG. 17 rather than repeating each topographical, operation, and functional detail again.

With reference to FIG. 18, there is shown a schematic diagrammatic illustration of an embodiment of a fuel cell based system 500 for generating electrical energy (voltage, current, and power) from one or more fuel cells including for example from a parallel, series, or parallel/series combination or array of fuel cells. In this system 500, one or a plurality of fuel cells or stacks 502 receives a fuel mixture, such as a liquid fuel 514 and air 512 including an oxidizer 515 such as oxygen (O₂) or other gas or air containing an oxidizer such as oxygen. In one embodiment, the liquid fuel 514 comprises a mixture of methanol and water. In one embodiment of the fuel cell 502 operating on a methanol and water mixture, the air 512 and dilute methanol/water fuel 514 are pumped into or otherwise flowed through the fuel cell stacks 502 and output as a combined air 516 plus water vapor (H₂O) 517 output, and a fuel 518 plus CO₂ 519 output, where the H₂O 517 and CO₂ 519 represent fuel cell reaction exhaust products. The air input 512, fuel input 514, air plus H₂O 516, 517 output, and fuel 518 plus CO₂ 519 output are coupled between the fuel cell(s) 502 and external components using tubes, channels, or other fluid and gas coupling devices and methods as are known in the art.

Operation of the fuel cell stacks 502 results in generation of a fuel cell electrical voltage (V_{FC}) 503, electrical current (I_{FC}) 504, and electrical power (P_{FC}) 505, between or across first and second terminals 508, 510 to which may be coupled an electrical load 511. Details of open circuit voltages, voltage under load, or other details of voltage, current, or power of the fuel cell are described elsewhere in this description.

Fuel cell 502 may be any fuel cell or fuel cell stack or combination of fuel cells or fuel cell stacks. As the maximum output voltage and/or current characteristics of a particular fuel cell or stack of fuel cells may be limited, it will frequently be required to provide a plurality of fuel cells or fuel cell stacks electrically serially coupled to provide a desired output voltage. Furthermore, as the current supplying capacity of a single fuel cell or fuel cell stack may be limited, it may similarly be required to configure a plurality of fuel cells or fuel cell stacks in an electrically parallel configuration. Therefore the fuel cell(s) block may generally include any series, parallel, or series/parallel combination to obtain the desired voltage, current, and output power characteristics. In addition, it may be desirable or required to provide multiple ones (multiple stacks) of these series, parallel, or series/parallel combinations so as to provide a desirable operation from the perspective of fuel and air (or oxidizer) provision, operating temperature, chemical fuel cell reaction kinetics, and/or other operational factors.

Embodiments of fuel cells are known in the art and described in the patents and patent applications referred to and incorporated by reference into this patent application and are not described in greater detail here.

One particularly advantageous embodiment of a fuel cell for use in conjunction with a portable cellular telephones, laptop computers, PDA's, electronic cameras and flash units, satellite telephones, lighting units, and other portable electrical and electronic devices and information appliances utilizes one or more stacks of fuel cells, that are capable of generating the voltage, current, and watts of power required to operate the devices for the desired period of time before refueling.

A different embodiment of the system 500 for use in conjunction with a higher power device such as a portable notebook computer utilizes two stacks of cells, that are capable of generating higher voltage, current, and power, for example voltage in the 10-20 volt range and power at least on the order of 25 watts of power. Additional cells may be combined to provide the desired or required voltage, current, and power performance levels appropriate to the device and application. For example, some devices may only require voltages having a magnitude of about 3 volts, other 5 volts, others 9 volts, still others 10-12 volts, others 20-24 volts, and still other higher, lower or intermediate voltages.

Attention is now directed to structure and operation of the system 500. By the term dilute fuel we mean a mixture or concentration of the fuel that is less than 100% of the fuel with one or more additional components. In one particularly advantageous embodiment, the dilute fuel is a dilute methanol plus water mixture. Particular exemplary ranges for methanol and water are known in the art and are further described in the other applications incorporated by reference herein.

Dilute fuel (for example, methanol plus water) is stored in a dilute fuel supply reservoir, such as dilute methanol reservoir 520, and pumped using a liquid pump 524 or otherwise flowed to a fuel input port of fuel cell stacks 502. Where a plurality of individual fuel cells or fuel cell stacks as they are commonly referred to are utilized, a single pump may be used to supply all of the fuel cells or fuel cell stacks using suitable distribution plumbing or a plurality of liquid pumps 524 may be utilized to pump the fuel into and through the fuel cell stacks. Where typically the number of liquid pumps 524 may match the number of fuel cell stacks 502, the number of dilute fuel cell or liquid pumps 524 may be greater than or less than the number of fuel cell stacks, the number depending on the operational requirements and operating characteristics of the fuel cells. Additional pumps may also or alternatively be provided for redundancy in the event of failure of a pump for critical applications.

Fuel cell stacks 502 also require an oxidizer for the fuel, easily and cheaply satisfied by air 512 containing its normally occurring constituent gasses including oxygen. This air desirably has a humidity appropriate to maintain fuel cell membrane operating characteristics.

Air 512 having the desired humidity is pumped by air pump 546 from a source (e.g. the local external environment of the system) of such air that for example has been subjected to some humidity exchange or conditioning device 566, such as may be provided by a humidity exchanger 566, into the fuel cell 502.

The humidity conditioning device 566, such as the humidity exchanger may receive fresh new air at atmospheric conditions from a new air intake port or orifice 563 and exhaust air at an air exhaust port or orifice 564. The exhausted air may either be a portion (or all) of air recovered from the fuel cell stacks or a portion (or all) of mixed new air and recovered air. (Recovery of air and removal of liquid water from the fuel cell stacks 502 is described hereinafter.)

The fuel and air inputs react over a membrane based fuel cell reaction chamber generating a potential voltage difference across anode and cathode poles of the individual fuel cells making up fuel cell stacks where present and/or across fuel cell stacks. The final fuel cell voltage (V_{FC}) may depend upon the chemistry associated with the individual fuel cell elements or reaction chambers, the number of such fuel cell elements or reaction chambers, the connectivity of the fuel cells in to series, parallel, and/or series/parallel combinations.

In one embodiment of the fuel cell 502 having two stacks, each stack has fuel cell elements or reaction chambers, operates with a chosen methanol:water ratio or dilution range, and the open circuit voltage across the fuel cell is set at a predetermined voltage or voltage range.

Fuel cell exhaust products are recovered from the fuel cell stacks and where possible and economically or otherwise viable from an economic and/or environmental sense are recovered and reused. For example, in the methanol/water system, the fuel cell stacks 502 outputs an air 516 plus water 517 mixture on one side of the fuel cell membrane (not shown) and a methanol/water 518 plus CO2 519 output on the other side of the membrane. The air plus water mixture is passed through an air/liquid or more simply a liquid water separator 554. The recovered air is directed to a humidity conditioning device, such as to a humidity exchanger 566 before being re-circulated to air pumps 546 and back to the fuel cell stacks 502. As already described, new air from air intake 563 may be introduced and recovered air or a mixture of recovered air and new air may be brought in or exhausted as required to obtain the desired air humidity characteristic. An air supply reservoir (not shown) may optionally be provided or the air reservoir may be eliminated relying on the various tubing, channels, and conduits between the output of the fuel cells and the air pump 546 to act as a reservoir.

Air/liquid water separator 554 also provides liquid water which may either be exhausted from the system 500 or recovered and reused. Recovery of liquid water is particularly advantageous when the system is provided with fuel supply replenishment subsystem described hereinafter.

Recall that in addition to the air input to the fuel cells, fuel is also input, and the fuel cell outputs a mixture of methanol/water plus CO₂. This mixture is passed through a fuel/CO₂ separator 534 which separates or removes CO₂ from the recirculating dilute methanol/water mixture. The CO₂ may be exhausted to the environment via CO2 exhaust 541 or recovered. The recovered dilute methanol/water mixture after CO2 separation and is then optionally but desirably processed to achieve a desired temperature range (usually by cooling) before adding it back to the dilute fuel supply tank 520. In this embodiment the temperature control (usually cooling) is achieved using a heat exchanger 521 including a thermostatically controlled cooling fan, and an input side and output side thermistor to monitor dilute methanol heat exchanger 521 input and output temperatures.

Once the recovered methanol/water mixture has been recovered to the dilute fuel supply tank or reservoir 520 it is available to pump back to the fuel cell stacks 502. (In the event that the system 500 is not configured to provide for fuel replenishment, such as when operating from a fixed volume of fuel mixture until that volume is consumed, a methanol/water separation device or drier 523 may be used to extract and recover water from the recovered fuel into a water reservoir 560 from the liquid water separator 554 and pumped with a water recovery pump 562 to dilute methanol tank 520, so as to minimize alteration of the desired methanol/water ratio.

Operational life of the system 500 between fuel cell stacks 502 refueling events is advantageously extended by providing a fuel supply replenishment subsystem 580. A concentrated fuel reservoir 574 stores a concentrated fuel (such as a high concentration of methanol, for example pure or nearly pure or undiluted methanol). As the volume or concentration of methanol in the dilute fuel supply tank 520 drops, a pump, such as a fuel metering pump 572 pumps high concentration methanol into the dilute fuel supply tank 520 to maintain or reestablish the desired ratio of methanol to water, and recovered water 558 is similarly pumped from a recovered water reservoir 560 by a water recovery pump 562 into the same dilute methanol fuel reservoir 520.

Various methods, systems, and control algorithms and procedures may be used to determine the replenishment of high concentration methanol and/or water, such as those based on predicted consumption over time, measure or monitored concentrations in the dilute fuel supply tank, output of one or more fuel cells, or other concentration sensors (CS), and tank level sensors (LS). In addition, temperature sensors (TS), typically in the form of thermistors are used to monitor conditions within the system 500.

In the embodiment of the system illustrated in FIG. 18 level sensors (LS) are provided in the dilute methanol tank 520 and optionally in the other tanks such as in the concentrated methanol tank 574 and the water reservoir tank 560. A concentration sensor is also advantageously provided in the dilute methanol tank 520 when periodic, continuous, or on-demand measurement or sensing of the methanol concentration is desired. This embodiment also provides temperature sensing thermistors to sense the temperature within the dilute methanol tank (thermistor #1), at the output of the liquid fuel pump 524 (thermistor #2), at the output of the fuel cell stacks 502 (thermistor #3 and #4), at the dilute fuel input (thermistor #5) and output (thermistor #6) of the optional heat exchanger 521. Having these sensors permits feed-back control as well as open-loop control or a combination of the two as desired or required.

FIG. 19 shows an alternative system 595 configuration of an embodiment of fuel cell powered electrical or electronic device such as an information appliance, PDA, or laptop computer. This embodiment differs from that illustrated and described relative to the embodiment in FIG. 18 in that the optional fuel reservoir having a concentrated methanol tank 574 and metering liquid pump 572 are not present for replenishment of the dilute methanol tank 520. Also absent from the FIG. 19 system 595 is the water recovery subsystem 523 and its water reservoir 560 and water recovery pump 562. In this system, water separated by the liquid water separator 554 is returned directly to the dilute methanol tank 520.

FIG. 20 shows yet another alternative system 596 similar to that described relative to FIG. 19 with the further simplification that the separate heat exchanger 521 is eliminated. In this embodiment the temperature of the dilute methanol fuel is achieved either via passive cooling or through the use of a cooling fan acting directly on the dilute methanol fuel tank. Advantageously but optionally, the cooling fan when provided is thermostatically controlled.

FIG. 21 shows yet another embodiment of the inventive system 597 and apparatus that is similar though not identical to that in FIG. 18. The primary difference other than the slightly different topology and layout of the system components is the elimination of the separate air pumps for the two (or more) stacks. In this embodiment, a single air pump 546 pumps air into an air balance control unit 590 that controls the volume and/or velocity of air provided to each of the two (or any plurality of) fuel cell stacks 502. It may be appreciated that where a large number of fuel cell stacks are configured, it may be desirable to provide a plurality of air pumps 546 each providing air to a plurality of fuel cell stacks, where the number of air pumps is smaller than the number of fuel cell stacks. In other embodiments, additional air pumps may be provided to provide additional air flow volume or speed or redundancy in the event of a failure.

It will be appreciated that features from one or the other of these embodiments may be combined in different ways to produce hybrid configurations.

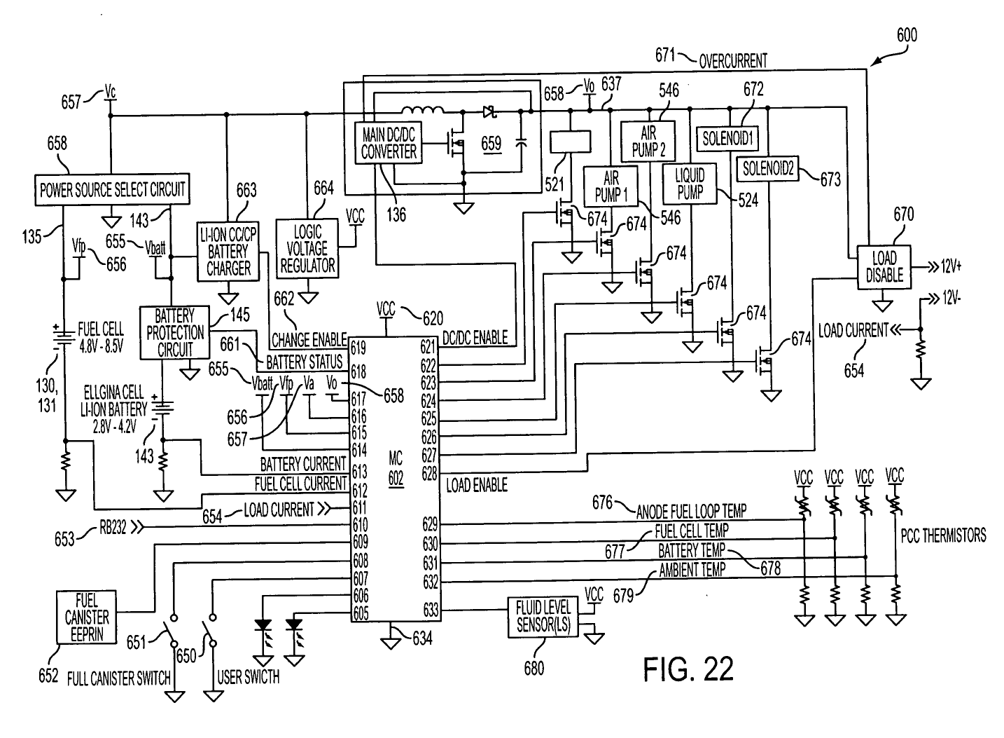

A particular embodiment of a power supply control system 600 diagram is illustrated in FIG. 22 with emphasis on the connectivity of the microcontroller to the boost converter, fuel cell circuits, actuators, and sensors. These physical components were previously shown and described relative to the embodiments in FIGS. 17-21 and elsewhere in this description. Aspects of the system electronics and control as well as aspects of the system components that provide reservoirs for water, fuel and dilute fuel, and that communicate and route air, fuel and water, between and among these components have also been described and illustrated relative to the embodiments of the invention. Certain monitoring and control procedures that may conveniently be implemented in software, firmware, or a combination of the two as well as in hard-wired or programmable logic if and when desired have also been described. The invention is also directed to such computer programs, software, firmware, and computer program products that include such computer program code and instructions. Memories storing such computer programs and computer program products are also within the scope of the invention.

FIG. 22 is a diagrammatic illustration that shows yet another embodiment of power supply control system along with these other components in a microprocessor based control scheme. Where possible, the reference numbers from earlier described embodiments are retained for convenient back reference and to minimize the amount of new non-redundant description required.

A microcontroller (or microprocessor) 602 provides important aspects of the overall system management and fuel cell and fuel cell device (e.g. laptop or personal computer) power supply control. In general a microcontroller having the lowest power consumption and capable of providing the desired performance is desirably used so that fuel system power consumption by the microcontroller it itself reduced or minimized. It will be noted however that operating voltage Vcc is received (pin 620) and that a ground pin is provided (pin 634).

In one embodiment of the invention microcontroller 602 is selected as a PIC18 series microcontroller made by MicroChip, Inc. Use of a microcontroller in the to be described configuration provides fully automated control including voltage, current, and temperature sensing, fuel and cathode water metering, anode temperature control, as well as other advantages. Power conditioning (DC-to-DC conversion) is provided for laptop computer as well as for other electronic device input. In addition, the control provides fuel cell, battery and overall power supply circuit protection. Advantageously, the fuel cell power supply operation is invisible to the user of the laptop computer or other device. This includes startup, proper operation, and shutdown. A simple switch and series of LEDs or other indicators may indicate operational status of the fuel cell unit. In a laptop computer implementation, it is advantageous for the fuel cell power supply to connect to the laptop via a standard DC-plug electrical attachment. Desirably, no modifications to the laptop electrical port are necessary. Another connection, directly to a laptop rechargeable battery pack may be required or desired in some embodiments.

Attention is first directed to several of the microcontroller (MC) 602 input and output ports (pins) and signals which are coupled for communication with other system components. As the operation of microcontrollers are generally known in the art for general applications, and data sheets for commercial products are readily available, only those signals which are relevant to the inventive system and control are described in detail here. Conventional signals and power to the microcontroller are conventional in nature and not described here.

MC 602 receives a user switch 650 signal (pin 607) and a fuel canister switch 651 signal (pin 608). These optional signals generally indicate that the user has activated the device and that the fuel canister is installed in the device. MC602 also receives signals from any (optional) fuel cell canister EEPROM 652 (pin 609) so that data may be received from or in some instances written to the fuel cell EEPROM. For example, the EEPROM 652 may identify a fuel cell canister voltage, fuel capacity, current or wattage rating, operating temperature range, or any other information or data that may be required or desirable for use of the fuel cell or the fuel cell canister.

MC 602 is also capable of receiving an IEEE RS-232 communication 653 as an input or output signal or set of signals (pin 610). This RS-232 may for example be useful for writing data, instructions, or commands to the microcontroller (such as for programming) as well as for reading data and status from the microcontroller such as for debugging or error processing. Other uses for communicating with a RS-232 or other standard interface are also applicable here and may alternatively be implemented.

MC 602 is also adapted to receive a load current 654 input made at load current measuring point or circuit location in the device. The fuel cell (or fuel cell stack) 202, 502 current I_{FC} may be input and sensed (pin 612), and similarly the standby or housekeeping battery 143 current may be input and sensed (pin 613). MC inputs for the housekeeping battery voltage Vbatt 655 (pin 614), the fuel cell stack output voltage VFC 656 (pin 615), the selected voltage (either VFC or Vbatt depending upon the state of the power source select circuit 658) VS 657 (pin 616), and the output of the main converter 136 and associated conditioning circuitry 659 VO 658 (pin 617) are also provided.

Battery status signals 661 from the battery protection circuit 145 are communicated to the MC (pin 618), and the MC is adapted to generate and communicate a charge enable signal 662 (pin 619) to battery charger circuit 663. The battery charger circuit 663 is also coupled to the battery 143 through the battery protection circuit 145 for charging and to the output of the power source selection circuit 658 VS 657.

Logic voltage regulator circuit 664 generates a voltage VCC that it communicates to the microcontroller (pin 620).

The microcontroller 602 is adapted to provide a DC-DC enable signal (pin 621) for coupling with circuit elements in the main converter 136, 659 to control operation or non-operation of the main boost converter as described elsewhere in this specification. A load enable signal (pin 622) may be generated by the microcontroller and communicated to a load control circuit 670 which is also coupled for signal communication with the main converter for an over-current signal 671 and the main converter output voltage VO 658. Operation of the load control 670 may enable or disable provision of the output voltage (e.g. +12 Vdc) to the connected load of the device (e.g. notebook computer).

MC 602 is also adapted to generate control signals (such as for example an enable signal(s) or to provide a operating voltage(s) to the various actuators such as to the fans 521, air pumps 546, liquid (water, fuel, or fuel mixture) pumps 524, solenoids 672, 672 that may be used to open and close values or provide other operation within the fuel cell system (pins 622-627). Various switching devices, relays, or other power handling or control devices or circuits 674 may be used in conjunction with operating and supplying operating power to the fans, pumps, solenoids, or other mechanical devices.

Likewise the microcontroller is adapted to receive sensor signals such as fluid level sensors, temperature sensors or thermistors, and concentration sensors. In this particular embodiment, sensor signals are received that measure anode fuel loop temperature 676 (pin 629), fuel cell temperature 677 (pin 630), battery temperature 678 (pin 631), ambient temperature 679 (pin 632), and a fluid level 680 (pin 633). These sensor measurements and signal are exemplary and the particular sensors and sensor signals may generally depend on the components installed in the fuel cell system and canister and the operational requirements of the system as well as on the nature of the control.

It will be appreciated in light of the description provided here that that not all control procedures will require or use all of the inputs or outputs to the microcontroller described here.

Having described one particular power management and control methodology, it will be appreciated that alternatives, variants, and enhancements to this power management and control methodology may be applied. A selection of these alternatives is described in the paragraphs immediately below.

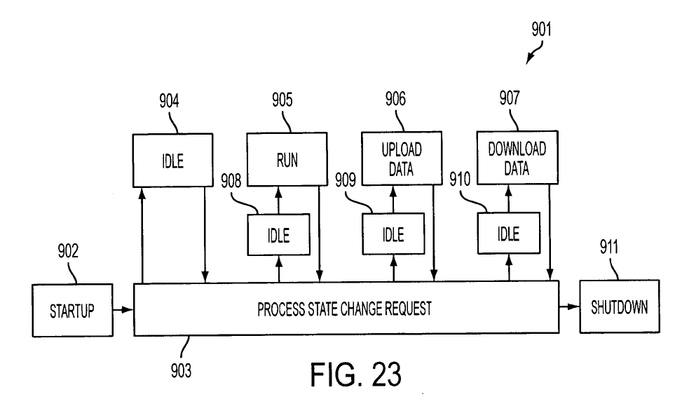

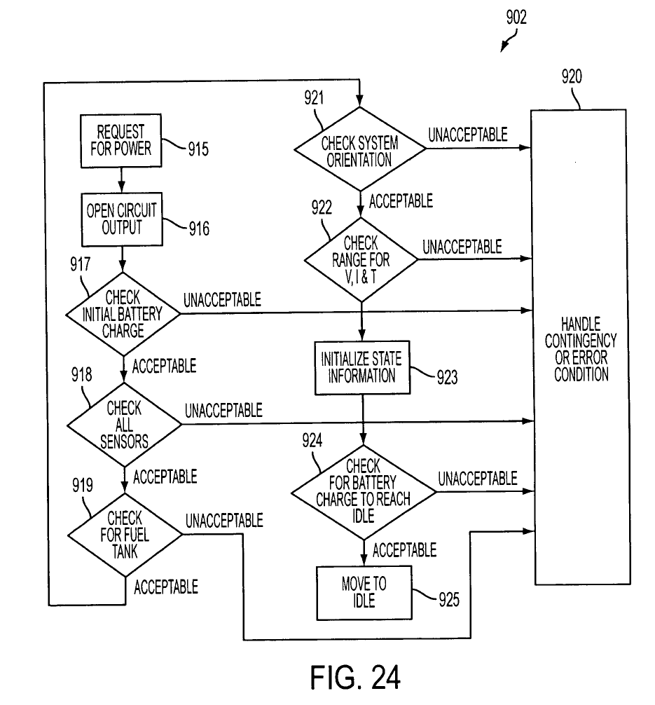

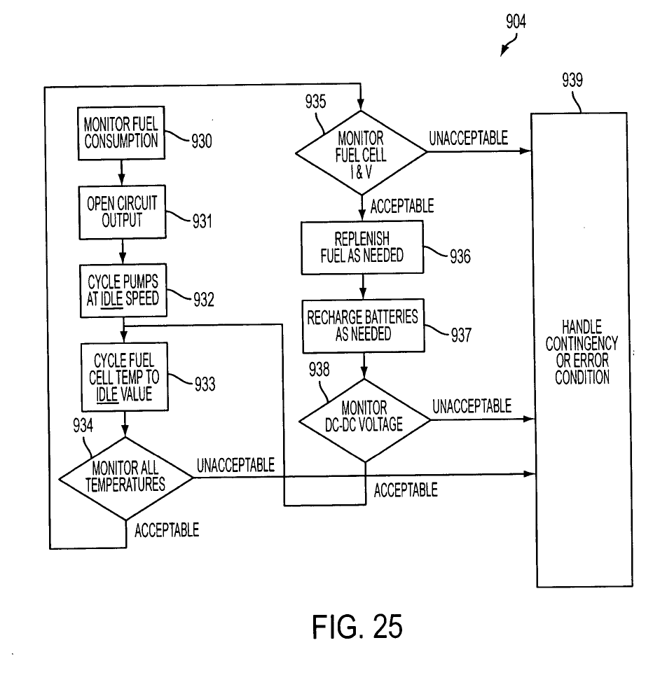

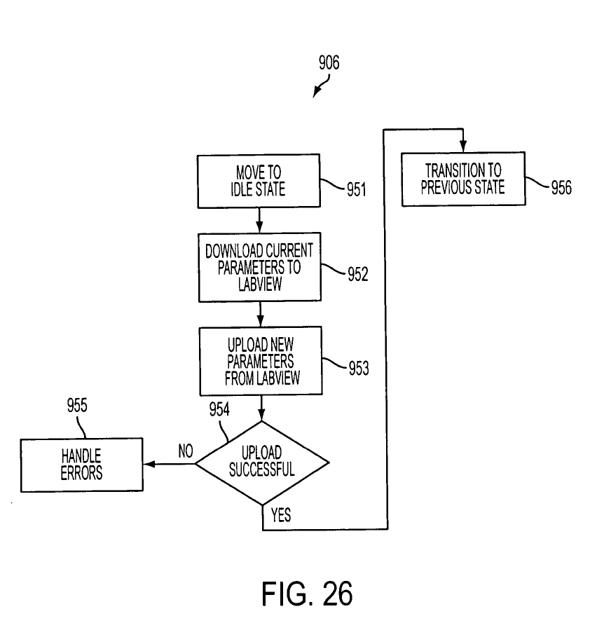

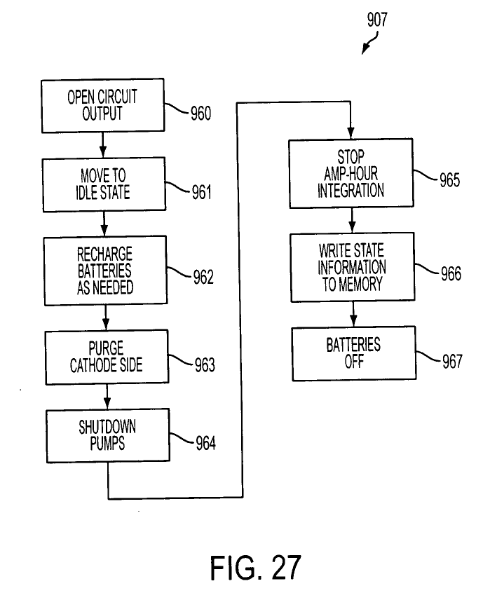

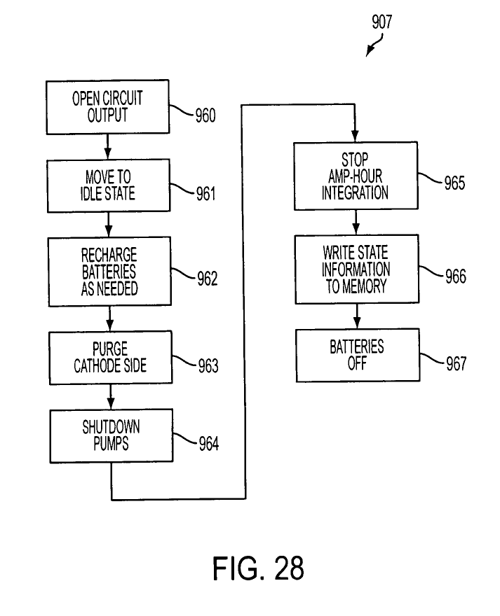

With reference to FIG. 23 there is illustrated an embodiment of a system control process and methodology 901. In this top-level or macroscopic perspective the various startup, idle, run, shutdown, and data up-load and data-download processes are described. After completing a startup sequence process 902, the system can transition between or among several of the processes such as the idle sequence process 904, run sequence process 905, data upload sequence process 906, and data download sequence process 907. Transitions occur via a process state change request process 903, and transition to run, upload data, and download data states occur visit an intermediate idle state process respectively. Transitions from run, upload data, and download data may occur directly to the process state change request state process. The system may also enter and remain in a shutdown state via a shutdown process 911. A detailed flowchart diagram of each of these startup sequence process 902 (See FIG. 24), idle sequence process 904 (See FIG. 25), run sequence process 905 (See FIG. 26), data upload sequence process 906 (See FIG. 27), and shutdown sequence process 911 (See FIG. 28)are also provided. In at least one embodiment of the invention, the data download sequence process 907 is similar to the data upload sequence process 906 except for the direction of data transfer and is not separately shown here.

These processes may advantageously be implemented as computer or machine program instructions for execution in logic (such as a micro-controller or microprocessor with associated coupled memory or register storage). In some embodiments the microcontroller or microprocessor may reside in the fuel cell container or cartridge while in other embodiments the microprocessor or microcontroller executing these instructions may reside in the device to be powered by the fuel cells, while in other embodiments microprocessors and/or microcontrollers in both may participate in the control.

In the section below are described additional exemplary embodiments of control procedures and sub-procedures that may be implemented in computer program software and firmware, or as a hybrid of hardware and software or firmware.

Exemplary Embodiments of Power Supply Software/Firmware Control

One particular embodiment of the inventive system provides a set of control procedures. These are referred to as the: System Initialization control procedure (UC0), the Startup control procedure (UC1), the Maintenance Of A Self-Sustaining Idle State control procedure (UC2), the Transition To/Maintenance Of A Power Supply Run State control procedure (UC3), the Shutdown control procedure (UC4), the Data Upload control procedure (UC5), and the Data Download/Debug Tracing control procedure (UC6). It will be appreciated that although these control algorithms and procedures are particularly useful with embodiments of the invention described herein, they may also or alternatively be applied in all or part to other systems. Each of the control procedures are now described relative to Tables 1-7 and include (where applicable) any preconditions and post conditions, any assumptions that are made, a main success flow path scenario, and any extensions or alternative flow paths that become applicable when predetermined or dynamically determined events or conditions arise. It will be appreciated that these procedures are exemplary and that none, some, or all of the preconditions, assumptions, post conditions, main success scenario elements, and alternative scenario elements may be eliminated and are optional or may be modified without departing from the scope of the invention.

TABLE 1
UC0: System Initialization

| | UC0: System Initialization |
|---|---|
| Preconditions | System is completely off. |
| Assumptions | Current through the fuel cell is zero. |
| Post | (a) All sensors are known to function correctly. |
| Conditions | (b) Fuel is available. |
| | (c) Battery power is sufficient to move to an idle state. |
| | (d) Output power rails are open circuit. |
| | (e) All pumps are off. |
| | (f) The system is known to be in an acceptable physical orientation. |
| Main Success | 1. Power is requested from the system. Either the user presses the “ON” button or |
| Scenario | the system senses a request for power from an external source. (For example, the |
| | user plugs the fuel cell system into the laptop computer or other device.) |
| | 2. The fuel cell is set to open circuit. |
| | 3. The output power rails are placed in an open circuit configuration. |
| | 4. The battery state-of-charge is checked to see if it can sustain the system through |
| | this initial startup phase. |
| | 5. All sensors are checked for proper functioning by determining if they are |
| | currently reading within an acceptable range. |
| | 6. Controller checks to see if a fuel tank is installed. |
| | 7. Controller checks to see if the system is within an acceptable orientation. |
| | 8. Controller initializes all necessary state information pertaining to amp-hour |
| | integration, and the like. |
| | 9. The voltage, current and temperature of the fuel cell are measured. A |
| | computation is preformed to determine an approximate lag time to reach a self- |
| | sustaining idle state. The batteries are checked to see if they can supply sufficient |
| | power for the duration of this lag time. |
| | 10. The system state is set to UC1. |
| Extensions | 1-10a: The user cancels the request for power. |
| | 1. The fuel canister state information is updated to reflect any fuel |
| | consumption. The controller ceases it's processing and shuts down. |
| | 1-10a: The batteries are fully discharged. |
| | 1. The system simply does not turn on. Connect the system to an external |
| | power supply. |
| | 1-10a: The user cancels the request for power. |
| | 1. The fuel canister state information is updated to reflect any fuel |
| | consumption. The controller ceases it's processing and shuts down. |
| | 1-10a: The batteries are fully discharged. |
| | 1. The system simply does not turn on. Connect the system to an external |
| | power supply. |
| | 3a: The battery is depleted and does not contain enough power to complete the |
| | startup phase. (Battery depletion is defined to be 5-10% of total charge. The 5-10% |
| | reserve charge value is used for completing the shutdown sequence, and |
| | consequently, assuring the system dies in a consistent state.) |
| | 1. The controller ceases it's processing and writes a failed startup error code to |
| | the non-volatile memory stating that the battery is depleted. The fuel canister is |
| | updated to reflect any fuel consumption. The controller ceases it's processing |
| | and shuts down: |
| | 4a: A sensor is reading a value that is not within an acceptable range. |
| | 1. The controller ceases it's processing and writes a failed startup error code to |
| | the non-volatile memory identifying the faulty sensor. The fuel canister is |
| | updated to reflect any fuel consumption. The controller shuts down. |
| | 5a: The fuel tank is not present. |
| | 1. The controller ceases it's processing and writes a failed startup error code to |
| | the non-volatile memory stating that the fuel tank is not present. A warning |
| | signal is presented to the user via the LEDs. The controller shuts down. |
| | 5b: The fuel tank is installed, but it is empty. |
| | 1. The controller ceases it's processing and writes a failed startup error code to |
| | the non-volatile memory stating that the fuel tank is empty. A warning signal |
| | is presented to the user via the LEDs. The controller shuts down. |
| | 6a: The system is currently oriented in a manner other than horizontal. |
| | 1. The controller ceases operation and a warning signal is presented to the user |
| | via the LEDs. The controller shuts down. |
| | 7a: The batteries are predicted to contain insufficient power to reach a self- |
| | sustaining idle state. |
| | 1. The controller proceeds with startup, but writes a low battery warning code |
| | to the non-volatile memory stating that the batteries are predicted to be |
| | insufficiently charged to reach a self-sustaining idle state. |

TABLE 2
UC1: Startup

| | UC1 Startup |
|---|---|
| Preconditions | The system initialization sequence described in UC0 has completed successfully. |
| Assumptions | There exists enough battery power to reach a self-sustaining idle state. |
| Post | The fuel cell is providing a stable power output sufficient to overcome the parasitic |
| Conditions | power losses. The internal batteries are open circuit from a power supply |
| | standpoint. |
| Main Success | 1. The fuel cell is open circuit and all power consumption is supplied via the |
| Scenario | internal battery. |
| | 2. Output power rails are set to open circuit. |
| | 3. Fuel consumption is monitored. Fuel consumption is computed via amp-hour |
| | integration, and ideally, via a small methanol concentration sensor. |
| | 4. The air pumps and fuel pumps are cycled to their idle speed. |
| | 5. The temperature of the fuel cell is brought to its idle value by appropriately |
| | cycling the fan and/or bypassing the heat exchanger as/if necessary. |
| | 6. The temperatures of the heat exchanger, fuel cell, batteries, and ambient |
| | environment are monitored. |
| | 7. The voltage across the fuel cell is monitored. |
| | 8. The current through the fuel cell is monitored. |
| | 9. Fuel is replenished to the system to maintain the proper stoichiometry. |
| | 10. The external voltage and current from the dc-to-dc converter are monitored. |
| | 11. Once the fuel cell has stabilized, the internal battery is switched to open circuit |
| | and the system is transitioned to UC2. |
| Extensions | 1-11a: The system is in the process of transitioning from initialization (UC0) to |
| (Alternative | the idle state and the batteries become fully discharged (See UC0, Extension |
| Paths) | 3a for a definition of fully discharged.) before adequate power is available |
| | from the fuel cell. |
| | 1. The controller shuts down all pumps. The fuel canister is updated to reflect any |
| | fuel consumption. An error code is presented to the user via the LEDs, and a |
| | failed startup code is written to the non-volatile memory stating that the batteries |
| | are depleted. The controller ceases it's processing. |
| | 1-11b: The user removes the fuel canister. |
| | 1. The system continues to operate at idle until the molarity drops below a |
| | predefined threshold. An error code is written to the non-volatile memory stating |
| | that the fuel canister was removed during operation. The batteries are checked for |
| | a full charge. If the batteries are not sufficiently charged, a warning code is written |
| | to the non-volatile memory stating that the system did not shut down cleanly. An |
| | error message is communicated to the user via the LEDs. |
| | 1-11c: The fuel canister is depleted. |
| | 1. The batteries are checked for a full charge. An empty fuel warning is |
| | communicated to the user via the LEDs. A predetermined time is allowed to |
| | elapse for the user to replace the canister. This will be equivalent to 1-3 |
| | ‘metering’ cycles, allowing for some minimum drop in anode loop molarity. The |
| | system continues to operate until the molarity drops below this predefined |
| | threshold. If a new fuel canister has not been inserted before the molarity drops |
| | below the predefined threshold, the system shuts down. If the batteries are not |
| | sufficiently charged, a warning code is written to the non-volatile memory stating |
| | that the system did not shut down cleanly. |

TABLE 3
UC2: Maintenance Of A Self-Sustaining Idle State

| | UC2: Maintenance Of A Self-Sustaining Idle State |
|---|---|
| Preconditions | The start up sequence described in UC1 has been satisfactorily completed. |
| Assumptions | The main scenario described below operates in an indefinite loop until a system |
| | state change is requested. |
| Post | The fuel cell is operating in a state such that it is only supplying sufficient power |
| Conditions | to overcome the parasitic power losses from the ancillary equipment and/or battery |
| | recharging. |
| Main Success | 1. Fuel consumption is monitored. Fuel consumption is computed via amp-hour |
| Scenario | integration, and ideally, via a small methanol concentration sensor. |
| | 2. Output power rails are set to open circuit. |
| | 3. The air pumps and fuel pumps are cycled to their idle speed. |
| | 4. The temperature of the fuel cell is brought to its idle value by appropriately |
| | cycling the fan and/or bypassing the heat exchanger as/if necessary. |
| | 5. The temperatures of the heat exchanger, fuel cell, batteries, and ambient |
| | environment are monitored. |
| | 6. The voltage across the fuel cell is monitored. |
| | 7. The current through the fuel cell is monitored. |
| | 8. Fuel is replenished to the system to maintain the proper stoichiometry. |
| | 9. The battery voltage is monitored and the batteries are recharged as necessary. |
| | 10. The external voltage and current from the dc-to-dc converter are monitored. |
| | 11. Requests for system state changes are monitored. |
| Extensions | 1-11a: The user removes the fuel canister. |
| (Alternative | 1. A predetermined time is allowed to elapse for the user to replace the canister. |
| Paths) | This will be equivalent to 1-3 ‘metering’ cycles, allowing for some minimum drop |
| | in anode loop molarity. The system continues to operate at an idle state until the |
| | molarity drops below this predefined threshold. If the fuel canister is not replaced |
| | before the molarity drops below the predefined threshold, the system shuts down. |
| | An error code is written to the non-volatile memory stating that the fuel canister |
| | was removed during operation. The batteries are checked for a full charge. If the |
| | batteries are not sufficiently charged, a warning code is written to the non-volatile |
| | memory stating that the system did not shut down cleanly. An error message is |
| | communicated to the user via the LEDs. |
| | 1-11b: The fuel canister is depleted. |
| | 1. The batteries are checked for a full charge. An empty fuel warning is |
| | communicated to the user via the LEDs. A predetermined time is allowed to |
| | elapse for the user to replace the canister. This will be equivalent to 1-3 |
| | ‘metering’ cycles, allowing for some minimum drop in anode loop molarity. The |
| | system continues to operate until the molarity drops below this predefined |
| | threshold. If a new fuel canister has not been inserted before the molarity drops |
| | below the predefined threshold, the system shuts down. If the batteries are not |
| | sufficiently charged, a warning code is written to the non-volatile memory stating |
| | that the system did not shut down cleanly. |
| | 5a: The temperature of the fuel cell exceeds its predefined range. |
| | 1. If the heat exchanger has been bypassed, the fluid is routed back through the |
| | heat exchanger. |
| | 2. If the fluid is flowing through the heat exchanger, the pumps are transitioned to |
| | the run state and the fuel cell is allowed to recover. If the temperature continues to |
| | rise, the system shuts down. |
| | 6a: The voltage across the fuel cell drops below an acceptable level. |
| | 1. With this, we will have to cycle-back on the fuel cell current. Depending on the |
| | battery charge, we may be able to allow the system to recover (i.e., the stack) |
| | before issuing a shutdown command and error code. |
| | 6b: The voltage across the fuel cell exceeds an acceptable level. |
| | 1. The system is immediately transferred to the shutdown sequence. An error code |
| | is written to the non-volatile ram stating that the fuel cell was over-voltaged. |
| | 9a: A request is received to change the state of the system. |
| | 1. The system is transitioned to the requested state. |
| | 10a: The voltage/current exceeds the predicted range. |
| | 1. This indicates that the balance-of-plant components are demanding too much |
| | power (or that the stack is not yet ready to handle itself). The converter will adjust |
| | to control the voltage/current, but the stack may have to be taken offline. Worst |
| | case, the entire system has to shutdown. |

TABLE 4
UC3: Transition To/Maintenance Of A Power Supply Run State

| | UC3: Transition To/Maintenance Of A Power Supply Run State |
|---|---|
| Preconditions | The start up sequence described in UC2 has been satisfactorily completed. The |
| | self-sustaining idle state has been achieved. |
| Assumptions | The main scenario described below operates in an indefinite loop until a system |
| | state change is requested. |
| Post | The fuel cell is operating in a state such that it is self-sustaining and supplying a |
| Conditions | usable output up to 15 watts. |
| Main Success | 1. Fuel consumption is monitored. Fuel consumption is computed via amp-hour |
| Scenario: | integration, and ideally, via a small methanol concentration sensor. |
| | 2. Output power rails are set to closed circuit. |
| | 3. The air pumps and fuel pumps are cycled to their run speed. |
| | 4. The temperature of the fuel cell is brought to its run value by appropriately |
| | cycling the fan and/or bypassing the heat exchanger as/if necessary. |
| | 5. The temperatures of the heat exchanger, fuel cell, batteries, and ambient |
| | environment are monitored. |
| | 6. The voltage across the fuel cell is monitored. |
| | 7. The current through the fuel cell is monitored. |
| | 8. Fuel is replenished to the system to maintain the proper stoichiometry. |
| | 9. The battery voltage is monitored and the batteries are recharged as necessary. |
| | 10. The external voltage and current output from the dc-dc converter AND output |
| | to the laptop are monitored. |
| | 11. Requests for system state changes are monitored. |
| Extensions | 1-11a: The user removes the fuel canister. |
| (Alternative | 1. The system continues to operate at the full run state allowing for 1-3 metering |
| Paths) | cycles to pass. If the fuel canister is not replaced, the system cycles back to idle |
| | (no battery charge) in an attempt to extend the life of the system. If, while in the |
| | idle state, the molarity drops below an acceptable level, the system initiates a |
| | shutdown. An error code is written to the non-volatile memory stating that the fuel |
| | canister was removed during operation. The batteries are checked for a full |
| | charge. If the batteries are not sufficiently charged, a warning code is written to the |
| | non-volatile memory stating that the system did not shut down cleanly. An error |
| | message is communicated to the user via the LEDs. |
| | 1-11b: The fuel canister is depleted. |
| | 1. The batteries are checked for a full charge. An empty fuel warning is |
| | communicated to the user via the LEDs. The system continues to operate at the |
| | full run state allowing for 1-3 metering cycles to pass. If the fuel canister is not |
| | replaced, the system cycles back to idle (no battery charge) in an attempt to extend |
| | the life of the system. If, while in the idle state, the molarity drops below an |
| | acceptable level, the system initiates a shutdown. If the batteries are not |
| | sufficiently charged, a warning code is written to the non-volatile memory stating |
| | that the system did not shut down cleanly. |
| | 5a: The temperature of the fuel cell exceeds its predefined range. |
| | 1. If the heat exchanger has been bypassed, the fluid is routed back through the |
| | heat exchanger. |
| | 2. If the fluid is flowing through the heat exchanger, the output power rails are |
| | placed in an open circuit configuration. The pumps continue to operate at the run |
| | state and the fuel cell is allowed to recover. If the temperature continues to rise, |
| | the system shuts down. |
| | 6a: The voltage across the fuel cell drops below an acceptable level. |
| | 1. With this, we will have to cycle-back on the fuel cell current. Depending on the |
| | battery charge, we may be able to allow the system to recover (i.e., the stack) |
| | before issuing a shutdown command and error code. |
| | 6b: The voltage across the fuel cell exceeds the open circuit value within a |
| | specified margin. |
| | 1. The system is immediately transferred to the shutdown sequence. An error code |
| | is written to the non-volatile ram stating that the fuel cell was over-voltaged. |
| | 9a: A request is received to change the state of the system. |
| | 1. The system is transitioned to the requested state. |
| | 10a: The voltage/current exceeds the predicted range. |
| | 1. This indicates that the balance-of-plant components are demanding too much |
| | power (or that the stack is not yet ready to handle itself). The converter will adjust |
| | to control the voltage/current, but the stack may have to be taken offline. Worst |
| | case, the entire system has to shutdown. The control system will have to act if a |
| | short-circuit occurs, etc. |

TABLE 5
UC4: Shutdown

| | UC4: Shutdown |
|---|---|
| Preconditions | The start up sequence described in UC0 has been satisfactorily completed. |
| Assumptions | Necessary power is available to shutdown |
| Post | All necessary system state information is stored in the non-volatile memory. The |
| Conditions | batteries are fully charged. Information regarding the amount of fuel remaining is |
| | written to the fuel canister. |
| Main Success | 1. Output rails are set to open circuit. |
| Scenario | 2. System is brought to an idle state (UC2) |
| | 3. Batteries are checked for a full charge. |
| | 4. Cathode side is purged, if necessary. (TBD from testing) |
| | 5. Pumps are shutdown. |
| | 6. Amp-hour integration halts. |
| | 7. Current state information is written to the non-volatile memory. |
| | 8. Batteries are shut off. |
| Extensions | 1-8a: The user removes the fuel canister. |
| (Alternative | 1. The system continues to operate potentially skipping one fuel metering cycle. |
| Paths) | An error code is written stating that the fuel canister is missing. Shutdown |
| | proceeds. |
| | 2. Amp-hour integration stops. |
| | 3. The batteries are checked for a complete charge. If the batteries are not fully |
| | charged, an improper shutdown warning code is written to the non-volatile |
| | memory. |
| | 4. Batteries are shut off. |
| | 3a: The batteries are not fully charged. |
| | 1. By default the system shuts down. However, the option to request that the |
| | system remain at idle until the batteries are topped off will be supplied through |
| | the data upload/download (e.g. LabView) computer microcontroller interface. |

TABLE 6
UC5: Data Upload

| | UC5: Data Upload |
|---|---|
| Preconditions: | The start up sequence described in UC1 has been satisfactorily completed. If the |
| | system is not running, sufficient battery power must exist to process the request. |
| Assumptions | — |
| Post | The new state variables are written to the non-volatile memory. |
| Conditions | |
| Main Success | 1. The current state of the system is noted. |
| Scenario | 2. If running, the system is transitioned to the idle state (UC2). Otherwise the |
| | batteries are brought online to supply power to the system. |
| | 3. Current state parameters are downloaded to LabView for storage. |
| | 4. New parameters are uploaded from LabView and overwrite the current set of |
| | parameters. |
| | 5. Notification is sent to LabView upon successful overwrite. |
| | 6. Transition to the previous operational state is invoked. |
| Extensions | 1-6a: The user removes the fuel canister. |
| (Alternative | 1. If the fuel cell is operating, a predetermined time is allowed to elapse for the |
| Paths | user to replace the canister. This will be equivalent to 1-3 ‘metering’ cycles, |
| | allowing for some minimum drop in anode loop molarity. The system continues to |
| | operate at an idle state until the molarity drops below this predefined threshold. If |
| | the fuel canister is not replaced before the molarity drops below the predefined |
| | threshold, the system switches to battery power. An error code is written to the |
| | non-volatile memory stating that the fuel canister was removed during operation. |
| | An error message is communicated to the user via the LEDs. |
| | 2. The battery charge is checked. If the batteries are not fully charged, an |
| | improper shutdown warning code is written to the non-volatile memory. |
| | 3. Upload continues under battery power. |
| | 4. The batteries are shut off and the system halts. |

TABLE 7
UC6: Data Download/Debug Tracing

| | UC6: Data Download/Debug Tracing |
|---|---|
| Preconditions | The start up sequence described in UC1 has been satisfactorily completed. If the |
| | system is not running, sufficient battery power must exist to process the request. |
| Assumptions | — |
| Post | All Debug information is transmitted according to the current polling rate. It is the |
| Conditions | responsibility of the LabView software to format, summarize, and/or plot the |
| | resulting data according to the user's request. |
| Main Success | 1. The current operational state of the system is unaffected. |
| Scenario | 2. All sensor parameters and state parameters are sent to LabView via simple |
| | character delimited format at the pre-determined polling rate. |
| Extensions | 1-2a: The battery does not have sufficient energy. |
| (Alternative | 1. An error code is written and shutdown occurs. |
| Paths) | |

Embodiment of a Fuel Cell Power Pack Powered Laptop Computer Having

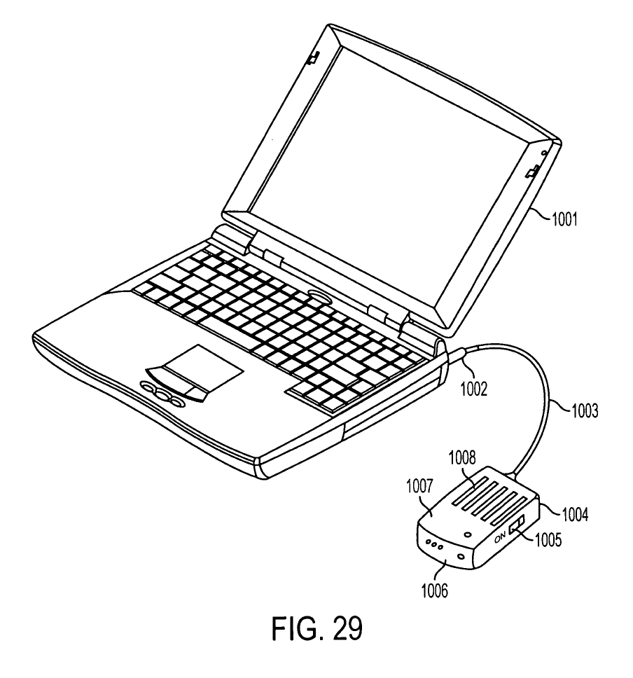

FIG. 29 is a diagrammatic illustration showing an embodiment of a laptop or notebook computer 1001 having a fuel cell power pack 1004 coupled to the DC battery input connector 1006 of the computer via a standard insulated electrical cable 1003. The fuel cell based power pack advantageously provides the interface and control circuitry internal to the fuel cell based power pack housing 1007 so that the pack is entirely self contained. One or a plurality of indicator lights in the form LEDs (or a LCD display) provide user information as to operational status, time remaining, available power, and the like. A simple on/off switch is also provided. Openings 1008 in the housing 1007 may be used to provide air and cooling. Additional apertures, ports, and couplings may be used to exchange and/or refill fluids. Advantageously, the power pack provides for an interchangeable fuel cartridge. The computer 1001 may also or alternatively mount and connect a power pack 1004 internal to the case of the computer and connect using mating connectors on the pack and the computer.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A fuel cell powered information appliance comprising:
an information appliance having a processor for executing computer instructions;
a memory or register communicatively coupled to said processor;
a fuel cell generating electrical power and coupled to at least one of said processor and said memory for providing operating power (voltage and current) to operating electrical circuits within said processor and memory.

2. The information appliance in claim 1, wherein said information appliance comprises a notebook computer.

3. The information appliance in claim 1, wherein said information appliance comprises a personal data assistant.

4. The information appliance in claim 1, wherein said fuel cell is integrated within a common housing that houses said processor.

5. The information appliance in claim 1, wherein said fuel cell is disposed external to a housing that houses said processor and provides said generated electrical power to said processor via an electrical conductor.

6. The information appliance in claim 1, wherein said fuel cell comprises a methanol fuel cell.

7. A fuel cell powered notebook computer.

8. A power pack adapted to provide electrical operating power to an electrical device, said power pack comprising:
a fuel cell assembly;
an electrical interface circuit receiving a voltage and current from said fuel cell assembly and generating an electrical output voltage and current for operation of said electrical device, said electrical interface including a controller executing a control procedure for managing operation of said fuel cell assembly and said electrical device according to a predetermined control procedure; and
a housing enclosing said fuel cell assembly and said electrical interface circuit.

9. A power pack according to claim 8, wherein said fuel cartridge is specifically adapted for use with a power pack specifically designed for a specific model of an electrical device and mounts to the device at a dedicated power coupling port.

10. A power pack according to claim 8, wherein the interface circuit comprising:
a DC-DC voltage boost circuit operating with an output voltage related feedback signal;
a storage capacitor coupled to and receiving charge generated by said boost circuit; and
a microcontroller coupled to said boost circuit for controlling operation or non-operation of said boost circuit.

11. A power pack according to claim 8, wherein the electrical device comprises a laptop or palmtop computing device.

12. A power pack according to claim 8, wherein the electrical device comprises a communication device.

13. A power pack according to claim 8, wherein the electrical device comprises a cellular telephone.

14. An interface circuit for a fuel cell powered electronic device comprising:
a DC-DC voltage boost circuit operating with an output voltage related feedback signal;
a storage capacitor coupled to and receiving charge generated by said boost circuit; and
a microcontroller coupled to said boost circuit for controlling operation or non-operation of said boost circuit.

15. An interface circuit as in claim 14, wherein the interface circuit is specifically adapted for use with a specific model of a cellular phone.

16. An interface circuit as in claim 14, wherein the interface circuit is adapted to control and regulate power drawn from and charge and discharge of a fuel cell and maintain safe operation within predefined voltage, current, and power ranges.

17. A method of controlling operation of a voltage boost converter circuit coupled to a fuel cell and another energy storage device.

18. A method for boosting a lower fuel cell voltage up to higher voltage for operation of an electrical device selected from the set of devices consisting of a cellular phone, a laptop computer, a palm top computer, a PDA, a radio, a radio-frequency transmitter, a radio-frequency receiver.

19. An interface circuit as in clam 14, wherein said interface circuit further comprises a battery and said voltage boost circuit limiting a battery charging current to a predetermined current less than a current that would damage said battery.

20. An interface circuit as in clam 14, wherein said boost circuit boosting the fuel cell voltage to a higher voltage level and for supplying charge to capacitive and battery storage devices within the circuit.

21. An interface circuit as in clam 14, wherein said microcontroller monitors at least a sample of the fuel cell output voltage to determine when to operate the boost circuit.

22. An interface circuit as in clam 21, wherein said microprocessor is adapted to execute computer program instructions to modify and control the operation of the microcontroller.

23. An interface circuit as in clam 22, wherein the computer program instructions include an instruction to perform a fuel cell load test including applying an incremental load to the fuel cell and determining a resulting fuel cell output voltage, the fuel cell load test being failed if the fuel cell in unable to maintain a predetermined output voltage level.

24. An interface circuit as in clam 23, wherein the boost circuit is not turned on or turned off if the fuel cell load test is failed.

25. An interface circuit as in clam 23, wherein the load test is performed only on the expiration of a counter count so that the load test is performed less frequently than ever execution cycle of a set of instructions executing in said microprocessor.

26. An interface circuit as in clam 23, wherein operation of the boost circuit is further regulated by hardware components that include feedback control elements.

27. An interface circuit for a fuel cell powered information appliance comprising:
a DC-DC voltage boost circuit operating with an output voltage related feedback signal to boost a lower fuel cell output voltage to a higher voltage operating voltage of said cellular telephone;
a storage capacitor and a storage battery coupled to and receiving charge generated by said boost circuit, said boot converter circuit further operating to limiting a storage battery charging current to a predetermined current less than a current that would damage said storage battery; and
a microcontroller adapted to execute instructions to modify and control the operation of the microprocessor and coupled to said boost circuit for controlling operation or non-operation of said boost circuit based on a fuel cell output voltage;
said interface circuit being adapted to control and regulate power drawn from and charge and discharge of a fuel cell and maintain safe operation within predefined voltage, current, and power ranges, and said cellular telephone having a power-consumption ranging between substantially 10 watts and 60 watts and an operating voltage range between substantially 5 volts and 20 volts.

28. A power pack specifically adapted to replace a battery for a laptop computer having a laptop computer body, said power pack comprising:
a fuel cell assembly;
a housing adapted to removably engage the laptop computer body, said housing enclosing said fuel cell assembly and said fuel cartridge; and
an interface circuit including: a DC-DC voltage boost circuit operating with an output voltage related feedback signal; a storage capacitor coupled to and receiving charge generated by said boost circuit; and a microcontroller coupled to said boost circuit for controlling operation or non-operation of said boost circuit.

29. A method of controlling a fuel cell power pack to provide electrical energy to operate an electronic device.

30. A method of controlling a fuel cell power pack as in claim 29, wherein the electronic device comprises a computer.
